(19) United States
(12) Patent Application Publication
(10) Pub. No.: US 2024/0353258 A1
(43) Pub. Date: Oct. 24, 2024

(54) PHOTOELECTRIC CONVERSION APPARATUS AND OPTICAL DETECTION SYSTEM

(71) Applicant: CANON KABUSHIKI KAISHA, Tokyo (JP)

(72) Inventors: YASUHARU OTA, Tokyo (JP); TOMOYA SASAGO, Kanagawa (JP)

(21) Appl. No.: 18/761,080

(22) Filed: Jul. 1, 2024

Related U.S. Application Data
(63) Continuation of application No. PCT/JP2022/000056, filed on Jan. 5, 2022.

(51) Int. Cl. G01J 1/44; G01C 3/10

(52) U.S. Cl. CPC G01J 1/44; G01C 3/10; G01J 2001/4466

(57) ABSTRACT

A photoelectric conversion apparatus includes a pixel including a photoelectric conversion unit for outputting a first signal in response to incidence of a photon, the photoelectric conversion unit including an avalanche diode for multiplying a charge occurring from the incidence of the photon by avalanche multiplication, a counter for counting a signal output from the photoelectric conversion unit, and a signal processing circuit connected between the counter and the photoelectric conversion unit and configured to control output of a third signal based on the first signal and a second signal. The signal processing circuit includes a first element having a first withstand voltage and a second element having a second withstand voltage and is configured such that the first signal is input to the first element and the second signal is input to the second element, the second withstand voltage being a withstand voltage lower than the first withstand voltage.

### CROSS-REFERENCE TO RELATED APPLICATIONS

This application is a Continuation of International Patent Application No. PCT/JP2022/000056, filed Jan. 5, 2022, which is hereby incorporated by reference herein in its entirety.

### BACKGROUND OF THE INVENTION

### Field of the Invention

The present invention relates to a photoelectric conversion apparatus and an optical detection system.

### Background Art

Single photon avalanche diodes (SPADs) are known as detectors capable of detecting light as weak as a single photon. SPADs multiply a signal charge excited by a photon about several to several million times using an avalanche multiplication phenomenon caused by a strong electric field induced at a semiconductor pn junction. The number of incident photons can be directly measured by converting the current caused by the avalanche multiplication phenomenon into a pulse signal and counting the number of pulse signals.

### CITATION LIST

### Patent Literature

PTL 1: Japanese Patent Application Laid-Open No. 2019-158806

An image sensor using SPADs includes a large number of constituent elements per pixel compared to a complementary metal-oxide-silicon (CMOS) image sensor. A reduction in the area of the pixel circuits is thus crucial in miniaturizing the pixels and improving the aperture ratio. PTL 1 discusses a technique for reducing the circuit area per pixel by configuring a plurality of light receiving units to share a recharge control unit. However, the technique discussed in PTL 1 is not directed to reducing the area of the pixel circuits themselves.

### SUMMARY OF THE INVENTION

The present invention is directed to improving the area efficiency of elements constituting pixel circuits, and by extension providing a photoelectric conversion apparatus and an optical detection system with pixel circuits of enhanced performance and functionality.

According to an aspect of the present invention, a photoelectric conversion apparatus includes pixel including a photoelectric conversion unit configured to output a first signal in response to incidence of a photon, the photoelectric conversion unit including an avalanche diode configured to multiply a charge occurring from the incidence of the photon by avalanche multiplication, a counter configured to count the first signal output from the photoelectric conversion unit, and a signal processing circuit connected between the counter and the photoelectric conversion unit and configured to control output of a third signal based on the first signal and a second signal, wherein the signal processing circuit includes a first element having a first withstand voltage and a second element having a second withstand voltage and is configured such that the first signal is input to the first element and the second signal is input to the second element, the second withstand voltage being a withstand voltage lower than the first withstand voltage.

According to another aspect of the present invention, a photoelectric conversion apparatus includes a pixel including a photoelectric conversion unit configured to output a first signal in response to incidence of a photon, the photoelectric conversion unit including an avalanche diode configured to multiply a charge occurring from the incidence of the photon by avalanche multiplication, a counter configured to count the first signal output from the photoelectric conversion unit, and a signal processing circuit connected between the counter and the photoelectric conversion unit and configured to control output of a third signal based on the first signal and a second signal, wherein the signal processing circuit includes a first element and a second element, and is configured such that the first signal is input to the first element and the second signal is input to the second element, and wherein a gate insulting film of a transistor included in the first element has a thickness greater than that of a gate insulating film of a transistor included in the second element.

Further features of the present invention will become apparent from the following description of exemplary embodiments with reference to the attached drawings.

### BRIEF DESCRIPTION OF THE DRAWINGS

FIG. 1 is a block diagram (1) illustrating a schematic configuration of a photoelectric conversion apparatus according to a first exemplary embodiment of the present invention.

FIG. 2 is a block diagram (2) illustrating a schematic configuration of the photoelectric conversion apparatus according to the first exemplary embodiment of the present invention.

FIG. 3 is a block diagram illustrating a configuration example of a pixel in the photoelectric conversion apparatus according to the first exemplary embodiment of the present invention.

FIG. 4 is a perspective view illustrating a configuration example of the photoelectric conversion apparatus according to the first exemplary embodiment of the present invention.

FIGS. 5A to 5C are diagrams for describing a basic operation of a photoelectric conversion unit in the photoelectric conversion apparatus according to the first exemplary embodiment of the present invention.

FIG. 6A is a diagram (1) for describing a configuration example of a signal processing circuit in the photoelectric conversion apparatus according to the first exemplary embodiment of the present invention. FIG. 6B is a diagram (1) for describing an operation of the signal processing circuit in the photoelectric conversion apparatus according to the first exemplary embodiment of the present invention.

FIG. 7A is a diagram (2) for describing a configuration example of a signal processing circuit in the photoelectric conversion apparatus according to the first exemplary embodiment of the present invention. FIG. 7B is a diagram (2) for describing an operation of the signal processing circuit in the photoelectric conversion apparatus according to the first exemplary embodiment of the present invention.

FIG. 8 is a plan view (1) illustrating a layout example of elements in the photoelectric conversion apparatus according to the first exemplary embodiment of the present invention.

FIGS. 9A and 9B are plan views (2) illustrating layout examples of elements in the photoelectric conversion apparatus according to the first exemplary embodiment of the present invention.

FIG. 10 is a plan view (3) illustrating a layout example of elements in the photoelectric conversion apparatus according to the first exemplary embodiment of the present invention.

FIG. 11 is a schematic cross-sectional view illustrating a configuration example of high withstand voltage transistors and low withstand voltage transistors used in the photoelectric conversion apparatus according to the first exemplary embodiment of the present invention.

FIGS. 12A to 12C are cross-sectional process diagrams (1) illustrating a method for manufacturing the high withstand voltage transistors and low withstand voltage transistors used in the photoelectric conversion apparatus according to the first exemplary embodiment of the present invention.

FIGS. 13A to 13C are cross-sectional process diagrams (2) illustrating a method for manufacturing the high withstand voltage transistors and low withstand voltage transistors used in the photoelectric conversion apparatus according to the first exemplary embodiment of the present invention.

FIG. 14 is a diagram for describing a modification example of the pixel according to the first exemplary embodiment of the present invention.

FIG. 15A is a timing chart for describing an operation of the modification example of the pixel according to the first exemplary embodiment of the present invention. FIG. 15B is a diagram illustrating the relationship between time and a count value and the relationship between time and timing code for describing an operation of the modification example of the pixel according to the first exemplary embodiment of the present invention. FIG. 15C is a diagram illustrating the relationship between time and a count value for describing an operation of the modification example of the pixel according to the first exemplary embodiment of the present invention.

FIG. 16 is a block diagram illustrating a schematic configuration of an optical detection system according to a second exemplary embodiment of the present invention.

FIG. 17 is a block diagram illustrating a schematic configuration of a distance image sensor according to a third exemplary embodiment of the present invention.

FIG. 18 is a schematic diagram illustrating a configuration example of an endoscopic surgery system according to a fourth exemplary embodiment of the present invention.

FIGS. 19A to 19C are schematic diagrams illustrating a configuration example of a moving body according to a fifth exemplary embodiment of the present invention.

FIG. 20 is a block diagram illustrating a schematic configuration of an optical detection system according to the fifth exemplary embodiment of the present invention.

FIG. 21 is a flowchart illustrating an operation of the optical detection system according to the fifth exemplary embodiment of the present invention.

FIGS. 22A and 22B are schematic diagrams illustrating configurations of an optical detection system according to a sixth exemplary embodiment of the present invention.

### DESCRIPTION OF THE EMBODIMENTS

Exemplary embodiments described below are intended to embody the technical concept of the present invention and does not limit the present invention. The sizes and positional relationships of members illustrated in the drawings may be exaggerated for the clarity of the description.

### First Exemplary Embodiment

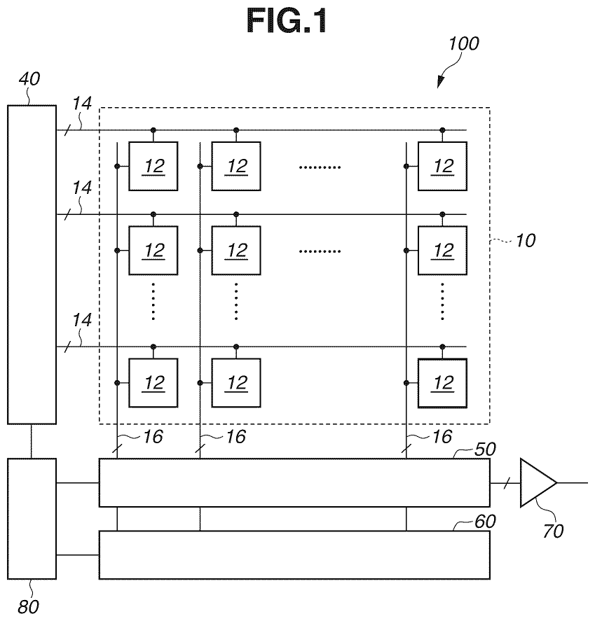

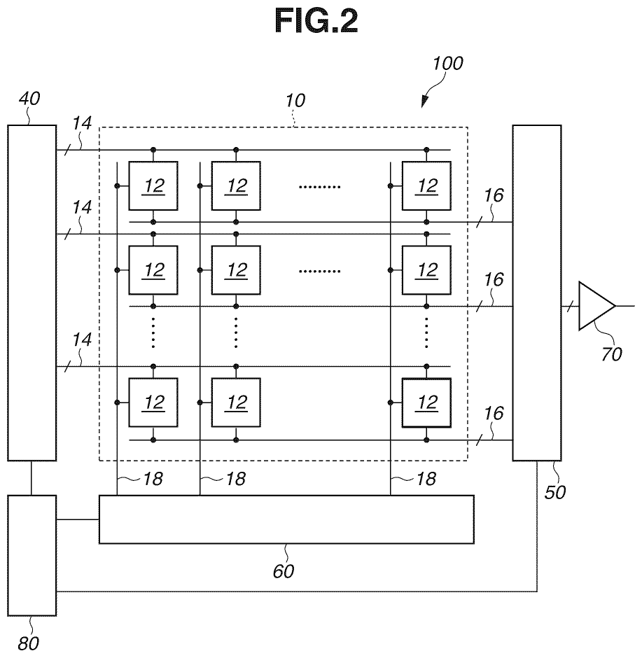

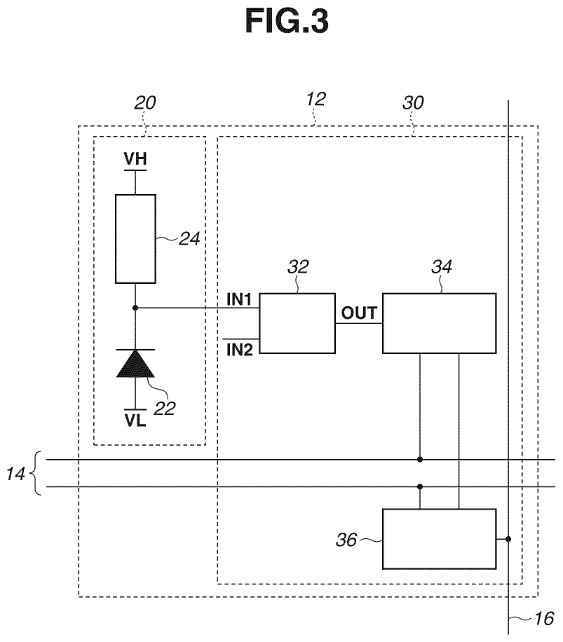

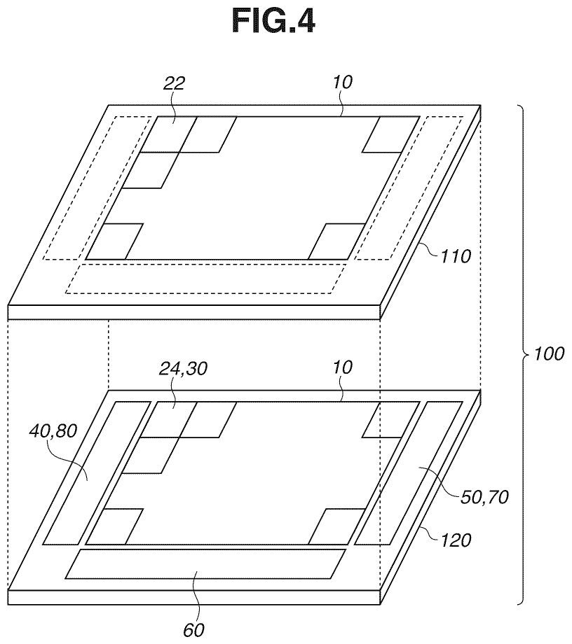

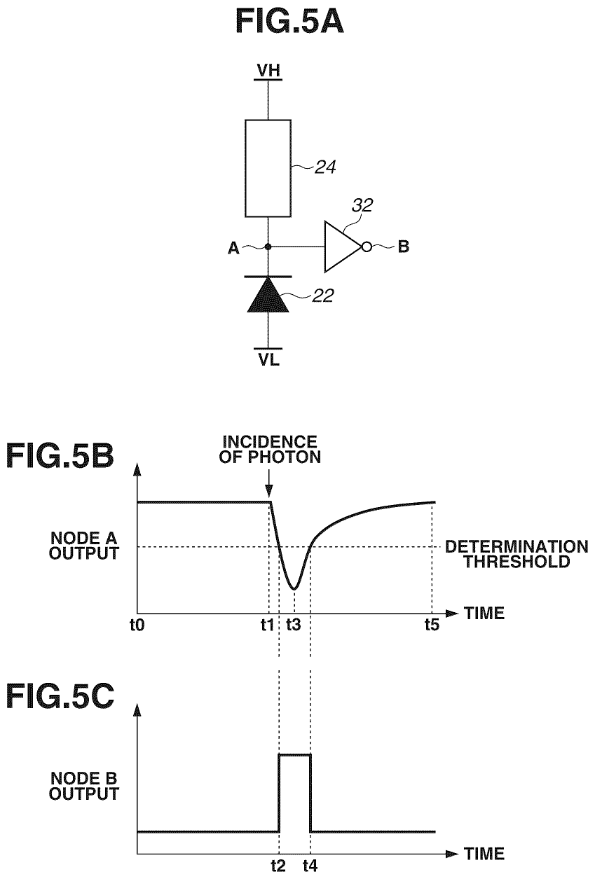

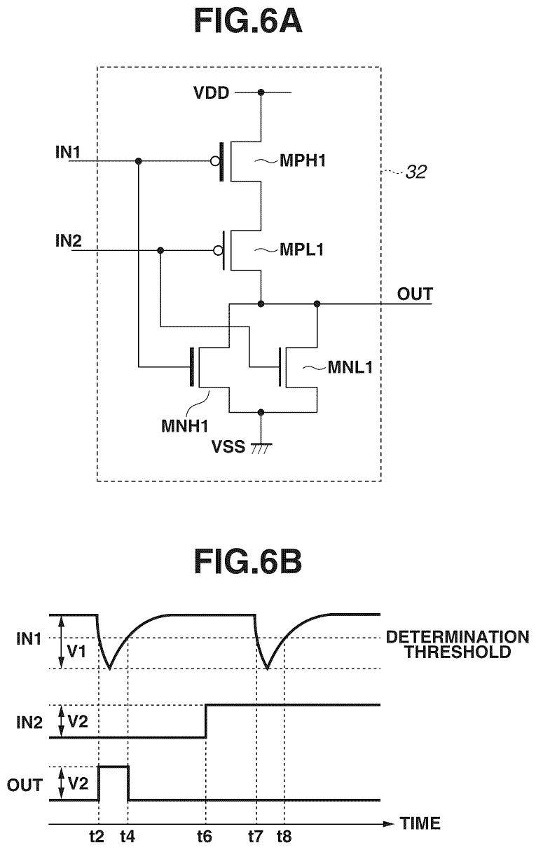

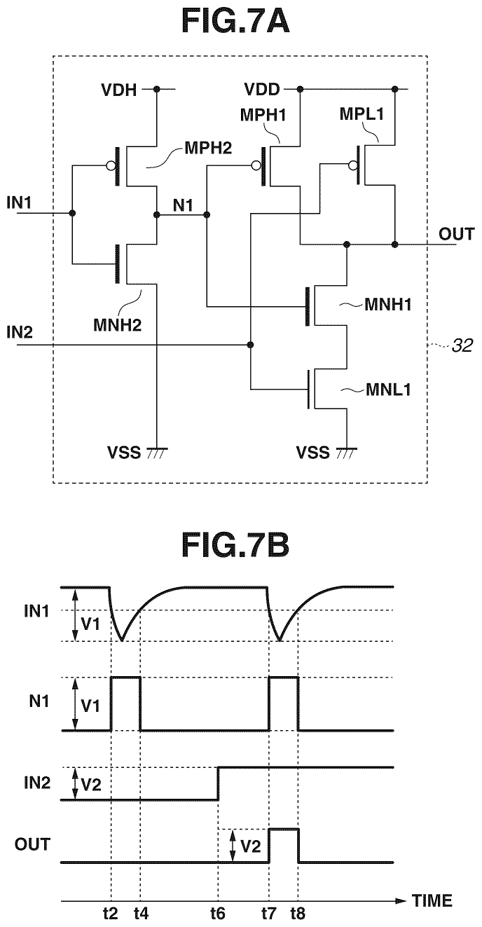

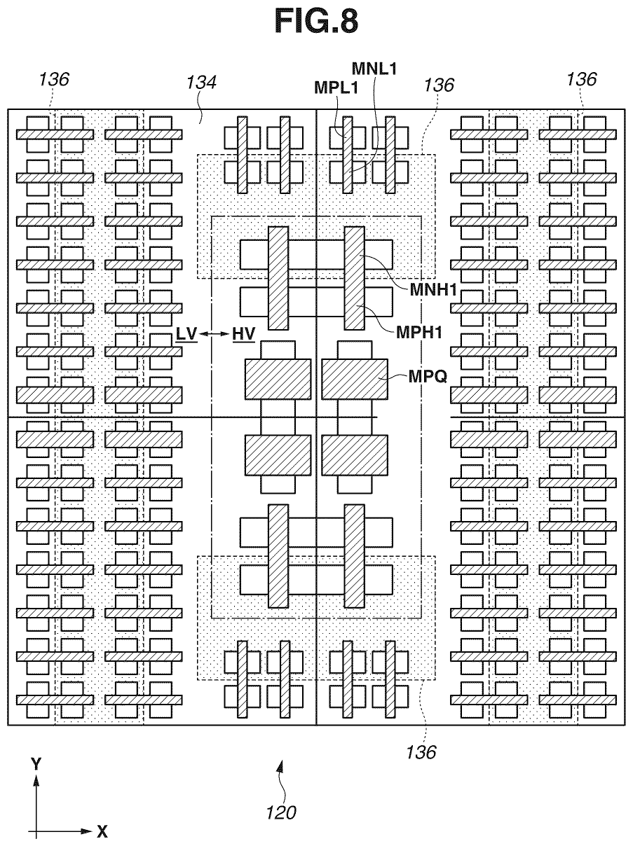

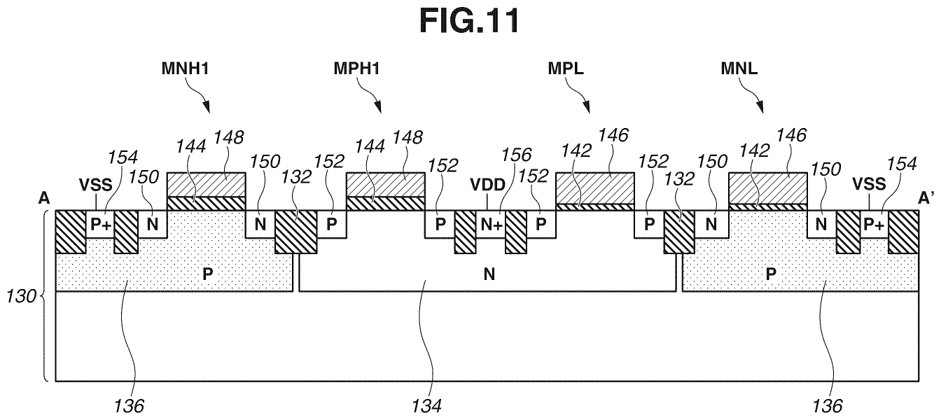

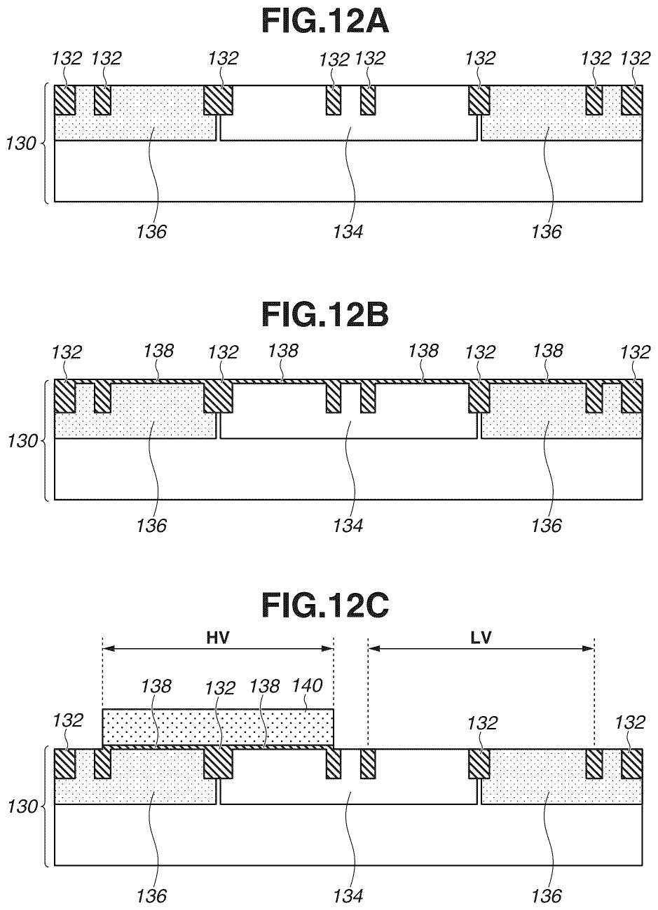

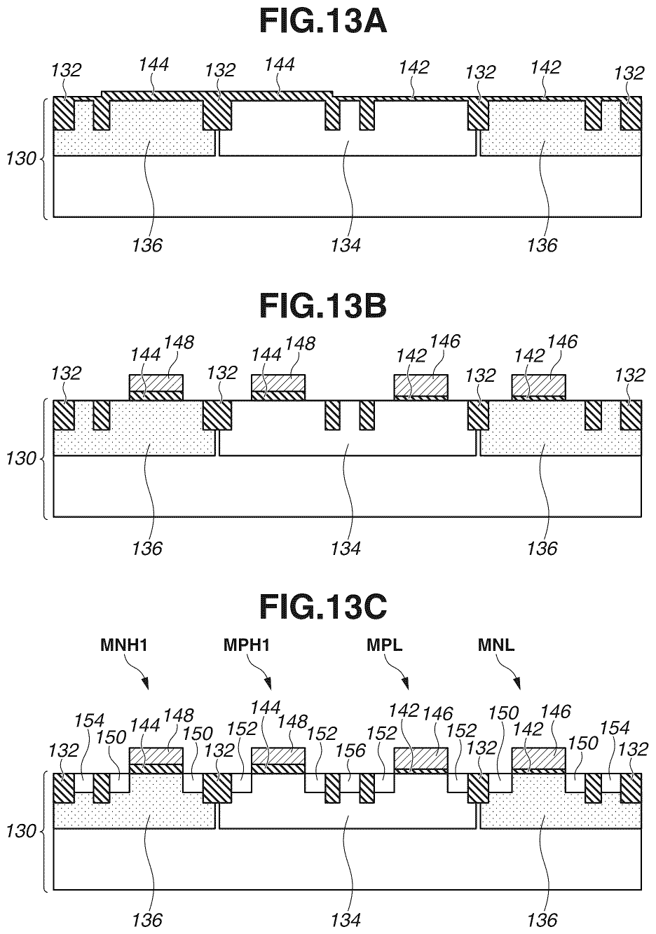

A photoelectric conversion apparatus according to a first exemplary embodiment of the present invention will be described with reference to FIGS. 1 to 13C. FIGS. 1 and 2 are block diagrams illustrating schematic configurations of the photoelectric conversion apparatus according to the present exemplary embodiment. FIG. 3 is a block diagram illustrating a configuration example of a pixel in the photoelectric conversion apparatus according to the present exemplary embodiment. FIG. 4 is a perspective view illustrating a configuration example of the photoelectric conversion apparatus according to the present exemplary embodiment. FIGS. 5A to 5C are diagrams for describing a basic operation of a photoelectric conversion unit in the photoelectric conversion apparatus according to the present exemplary embodiment. FIGS. 6A, 6B, 7A, and 7B are diagrams for describing configuration examples and operation of a signal processing circuit in the photoelectric conversion apparatus according to the present exemplary embodiment. FIGS. 8 to 10 are plan views illustrating layout examples of elements in the photoelectric conversion apparatus according to the present exemplary embodiment. FIG. 11 is a schematic cross-sectional view illustrating a configuration example of high withstand voltage transistors and low withstand voltage transistors used in the photoelectric conversion apparatus according to the present exemplary embodiment. FIGS. 12A to 12C and 13A to 13C are cross-sectional process diagrams illustrating a method for manufacturing the high withstand voltage transistors and low withstand voltage transistors used in the photoelectric conversion apparatus according to the present exemplary embodiment.

As illustrated in FIG. 1, a photoelectric conversion apparatus 100 according to the present exemplary embodiment includes a pixel unit 10, a vertical scanning circuit unit 40, a reading circuit unit 50, a horizontal scanning circuit unit 60, an output circuit unit 70, and a control pulse generation unit 80.

The pixel unit 10 includes a plurality of pixels 12 arranged in an array with a plurality of rows and a plurality of columns. As will be described below, each pixel 12 can include a photoelectric conversion unit including a photon detection element, and a pixel signal processing unit that processes a signal output from the photoelectric conversion unit. The number of pixels 12 constituting the pixel unit 10 is not limited in particular. For example, like a common digital camera, the pixel unit 10 can include a plurality of pixels 12 arranged in an array with several thousands of rows×several thousands of columns. Alternatively, the pixel unit 101 may include a plurality of pixels 12 arranged in a row or column. Alternatively, the pixel unit 10 may be constituted by a single pixel 12.

Each row of the pixel array of the pixel unit 10 includes a control line 14 extending in a first direction (lateral direction in FIG. 1). The control line 14 is connected to each of the pixels 12 arranged in the first direction and serves as a common signal line for the pixels 12. The first direction in which the control line 14 extends may be referred to as a row direction or a horizontal direction. Each control line 14 can include a plurality of signal lines for supplying a plurality of types of control signals to the pixels 12.

Each column of the pixel array of the pixel unit 10 includes a data line 16 extending in a second direction (vertical direction in FIG. 1) intersecting the first direction. The data line 16 is connected to each of the pixels 12 arranged in the second direction, and serves as a common signal line for the pixels 12. The second direction in which the data line 16 extends may be referred to as a column direction or a vertical direction. Each data line 16 can include a plurality of signal lines for transferring multibit digital signals output from the pixels 12 bit by bit.

The column line 14 in each row is connected to the vertical scanning circuit unit 40. The vertical scanning circuit unit 40 is a control unit having a function of receiving control signals output from the control pulse generation unit 80, generating control signals for driving the pixels 12, and supplying the control signals to the pixels 12 via the control lines 14. As the vertical scanning circuit unit 40, logic circuits, such as a shift register and an address decoder, can be used. The vertical scanning circuit unit 40 sequentially scans the pixels 12 in the pixel unit 10 row by row to read pixel signals from the pixels 12 and output the pixel signals to the reading circuit unit 50 via the data lines 16.

The data line 16 in each column is connected to the reading circuit unit 50. The reading circuit unit 50 includes a plurality of holding units (not illustrated) disposed to correspond to the respective columns of the pixel array of the pixel unit 10. The reading circuit unit 50 has a function of holding the pixel signals of the pixels 12 in the respective columns, output from the pixel unit 10 via the data lines 16 row by row, in the holding units of the corresponding columns.

The horizontal scanning circuit unit 60 is a control unit that receives control signals output from the control pulse generation unit 80, generates control signals for reading the pixel signals from the holding units of the respective columns in the reading circuit unit 50, and supplies the generated control signals to the reading circuit unit 50. As the horizontal scanning circuit unit 60, logic circuits, such as a shift register and an address decoder, can be used. The horizontal scanning circuit unit 60 sequentially scans the holding units of the respective columns in the reading circuit unit 50, and sequentially outputs the pixel signals held in the holding units to the output circuit unit 70.

The output circuit unit 70 is a circuit unit including an external interface circuit and intended to output the pixel signals output from the reading circuit unit 50 to outside the photoelectric conversion apparatus 100. The external interface circuit included in the output circuit unit 70 is not limited in particular. For example, a low voltage differential signaling (LVDS) circuit or a scalable low voltage signaling (SLVS) circuit can be applied to the external interface circuit. In other words, a serializer/deserializer (SerDes) transmission circuit can be applied to the external interface circuit.

The control pulse generation unit 80 is a control circuit intended to generate control signals for controlling the operation and timing of the vertical scanning circuit unit 40, the reading circuit unit 50, and the horizontal scanning circuit unit 60, and to supply the control signals to the functional blocks. At least some of the control signals for controlling the operation and timing of the vertical scanning circuit unit 40, the reading circuit unit 50, and the horizontal scanning circuit unit 60 may be supplied from outside the photoelectric conversion apparatus 100.

The connection mode of the functional blocks of the photoelectric conversion apparatus 100 is not limited to that of the configuration example in FIG. 1. For example, the photoelectric conversion apparatus 100 can be configured as illustrated in FIG. 2.

In the configuration example of FIG. 2, each row of the pixel array of the pixel unit 10 includes a data line 16 extending in the first direction. The data line 16 is connected to each of the pixels 12 arranged in the first direction and serves as a common signal line for the pixels 12. Each column of the pixel array of the pixel unit 10 includes a control line 18 extending in the second direction. The control line 18 is connected to each of the pixels 12 arranged in the second direction and serves as a common signal line for the pixels 12.

The control line 18 in each column is connected to the horizontal scanning circuit unit 60. The horizontal scanning circuit unit 60 receives control signals output from the control pulse generation unit 80, generates control signals for reading the pixel signals from the pixels 12, and supplies the control signals to the pixels 12 via the control lines 18. Specifically, the horizontal scanning circuit unit 60 sequentially scans the plurality of pixels 12 of the pixel unit 10 column by column, and outputs the pixel signals of the pixels 12 in the respective rows belonging to the selected column to the data lines 16.

The data line 16 in each row is connected to the reading circuit unit 50. The reading circuit unit 50 includes a plurality of holding units (not illustrated) disposed to correspond to the respective rows of the pixel array of the pixel unit 10. The reading circuit unit 50 has a function of holding the pixel signals of the pixels 12 in the respective rows, output from the pixel unit 10 via the data lines 16 column by column, in the holding units of the corresponding rows.

The reading circuit unit 50 receives control signals output from the control pulse generation unit 80, and sequentially outputs the pixel signals held in the holding units of the respective rows to the output circuit unit 70.

Other configurations in the configuration example of FIG. 2 can be similar to those of the configuration example of FIG. 1.

As illustrated in FIG. 3, each pixel 12 includes a photoelectric conversion unit 20 and a pixel signal processing unit 30. The photoelectric conversion unit 20 includes a photon detection element 22 and a quenching element 24. The pixel signal processing unit 30 includes a signal processing circuit 32, a counter 34, and a pixel output circuit 36.

The photon detection element 22 can be an avalanche photodiode (APD). The anode of the APD constituting the photon detection element 22 is connected to a node to which a voltage VL is supplied. The cathode of the APD constituting the photon detection element 22 is connected to one terminal of the quenching element 24. The connection node between the photon detection element 22 and the quenching element 24 serves as an output node of the photoelectric conversion unit 20. The other terminal of the quenching element 24 is connected to a node to which a voltage VH higher than the voltage VL is supplied. The voltages VL and VH are set such that a reverse bias voltage sufficient for the APD to cause an avalanche multiplication operation is applied. For example, a negative high voltage is applied as the voltage VL, and a positive voltage approximately as high as a power supply voltage is applied as the voltage VH. For example, the voltage VL is −30 V (volts), and the voltage VH is 1 V.

As described above, the photon detection element 22 can be constituted by an APD. With a reverse bias voltage sufficient to cause an avalanche multiplication operation supplied to the APD, a charge occurring from incidence of light on the APD causes avalanche multiplication to generate an avalanche current. Examples of operation mode with a reverse bias voltage supplied to the APD include a Geiger mode and a linear mode. The Geiger mode is an operation mode where the voltage applied across the anode and the cathode is a reverse bias voltage higher than the breakdown voltage of the APD. The linear mode is an operation mode where the voltage applied across the anode and the cathode is a reverse bias voltage near the breakdown voltage of the APD or lower than or equal to the breakdown voltage. APDs operating in the Geiger mode are called single photon avalanche diodes (SPADs). The APD constituting the photon detection element 22 may be configured to operate in the linear mode or the Geiger mode. In particular, SPADs can exhibit a high potential difference and a pronounced withstand voltage effect compared to APDs in the linear mode.

The quenching element 24 has a function of converting a change in the avalanche current occurring from the photon detection element 22 into a voltage signal. The quenching element 24 also has a function of serving as a load circuit (quenching circuit) in multiplying a signal by avalanche multiplication, and thereby reducing the voltage applied to the photon detection element 22 to suppress the avalanche multiplication. The operation of the quenching element 24 suppressing avalanche multiplication is referred to as a quenching operation. The quenching element 24 has a function of restoring the voltage supplied to the photon detection element 22 to the voltage VH by passing a current as much as the voltage drop caused by the quenching operation. The operation of the quenching element 24 restoring the voltage supplied to the photon detection element 22 to the voltage VH is referred to as a recharging operation. The quenching element 24 can be constituted by a resistive element or a metal-oxide-semiconductor (MOS) transistor.

The signal processing circuit 32 has an input node to which a signal IN1 that is the output signal of the photoelectric conversion unit 20 is supplied, an input node to which a signal IN2 is supplied, and an output node. The signal processing circuit 32 has a function as a waveform shaping unit for converting the analog signal IN1 supplied from the photoelectric conversion unit 20 into a pulse signal. The signal IN2 is a selection signal for selecting whether to output the pulse signal based on the signal IN1 from the output node. The signal IN2 is supplied from the control pulse generation unit 80. The output node of the signal processing circuit 32 is connected to the counter 34. If the quenching element 24 is constituted by a MOS transistor, the signal input to the gate of the MOS transistor and the signal IN2 may be derived from the same node. For example, a clock signal may be input as both the signal to the gate of the MOS transistor constituting the quenching element 24 and the signal IN2.

The counter 34 has an input node to which a signal OUT that is the output signal of the signal processing circuit 32 is supplied, an input node connected to the control line 14, and an output node. The counter 34 has a function of counting pulses superposed on the signal OUT output from the signal processing circuit 32 and holding a count value that is the counting result. Signals supplied from the vertical scanning circuit unit 40 to the counter 34 via the control line 14 include an enable signal for controlling the pulse counting period (exposure period) and a reset signal for resetting the count value held in the counter 34. The output node of the counter 34 is connected to the data line 16 via the pixel output circuit 36.

The pixel output circuit 36 has a function of switching the state of electrical connection (connection or disconnection) between the counter 34 and the data line 16. The pixel output circuit 36 switches the state of connection between the counter 34 and the data line 16 based on a control signal supplied from the vertical scanning circuit unit 40 via the control line 14 (in the configuration example of FIG. 2, a control signal supplied from the horizontal scanning circuit unit 60 via the control unit 18). The pixel output circuit 36 can include a buffer circuit for outputting a signal.

The pixel 12 is typically a unit structure that outputs a pixel signal for forming an image. However, if time-of-flight (ToF) ranging is intended, the pixel 12 does not necessarily need to be a unit structure that outputs a pixel signal for forming an image. In other words, the pixel 12 can be a unit structure that outputs a signal for measuring the time of arrival and the amount of light.

The pixel signal processing unit 30 does not necessarily need to be provided for each pixel 12 on a one-to-one basis. Instead, a single pixel signal processing unit 30 may be provided for a plurality of pixels 12. In such a case, the signal processing of the plurality of pixels 12 can be sequentially performed using the single pixel signal processing unit 30.

The photoelectric conversion apparatus 100 according to the present exemplary embodiment may be formed on a single substrate or configured as a stacked photoelectric conversion apparatus including a plurality of substrates stacked together. In the latter case, for example, as illustrated in FIG. 4, a sensor substrate 110 and a circuit substrate 120 can be stacked and electrically connected to constitute the stacked photoelectric conversion apparatus. Of the components of the pixels 12, at least the photon detection elements 22 can be disposed on the sensor substrate 110. The quenching elements 24 and the pixel signal processing units 30 among the components of the pixels 12 can be disposed on the circuit substrate 120. The photon detection elements 22 are electrically connected with the quenching elements 24 and the pixel signal processing units 30 via connection wiring disposed in the respective pixels 12. The vertical scanning circuit unit 40, the reading circuit unit 50, the horizontal scanning circuit unit 60, the output circuit unit 70, and the control pulse generation unit 80 can be further disposed on the circuit substrate 120.

The photon detection element 22, the quenching element 24, and the pixel signal processing unit 30 in each pixel 12 are disposed on the sensor substrate 110 and the circuit substrate 120 to overlap in a plan view. The vertical scanning circuit unit 40, the reading circuit unit 50, the horizontal scanning circuit unit 60, the output circuit unit 70, and the control pulse generation unit 80 can be disposed around the pixel unit 10 constituted by the plurality of pixels 12.

As employed herein, a “plan view” refers to a view in a direction perpendicular to the light incident surface of the sensor substrate 110. A “cross section” refers to a section perpendicular to the light incident surface of the sensor substrate 110.

The configuration of the stacked photoelectric conversion apparatus 100 can increase the degree of integration of the elements for higher functionality. In particular, since the photon detection elements 22 are disposed on a substrate different from that of the quenching elements 24 and the pixel signal processing units 30, the photon detection elements 22 can be densely arranged without sacrificing the light receiving area of the photon detection elements 22, whereby the photon detection efficiency can be improved.

The number of substrates constituting the photoelectric conversion apparatus 100 is not limited to two. Three or more substrates may be stacked to constitute the photoelectric conversion apparatus 100.

In FIG. 4, diced chips are assumed as the sensor substrate 110 and the circuit substrate 120. However, the sensor substrate 110 and the circuit substrate 120 are not limited to chips. For example, the sensor substrate 110 and the circuit substrate 120 may be a wafer each. The sensor substrate 110 and the circuit substrate 120 may be stacked in a wafer state and then diced, or diced into respective chips and then stacked and bonded.

FIGS. 5A to 5C are diagrams for describing a basic operation of the photoelectric conversion unit 20 and the signal processing circuit 32. FIG. 5A is a circuit diagram of the photoelectric conversion unit 20 and the signal processing circuit 32. FIG. 5B illustrates a signal waveform at the input node (node A) of the signal processing circuit 32. FIG. 5C illustrates a signal waveform at the output node (node B) of the signal processing circuit 32. For the simplicity of description, the signal processing circuit 32 here is assumed to be an inverter circuit.

At time t0, a reverse bias voltage as high as a potential difference (VH-VL) is applied to the photon detection element 22. The reverse bias voltage applied across the anode and the cathode of the APD constituting the photon detection element 22 is sufficient to cause avalanche multiplication, but without a photon incident on the photon detection element 22, there is no carrier to trigger the avalanche multiplication. The photon detection element 22 therefore does not cause avalanche multiplication, and no current flows through the photon detection element 22.

Suppose that a photon is incident on the photon detection element 22 at the subsequent time t1. The incidence of the photon on the photon detection element 22 generates an electron-hole pair through photoelectric conversion. These carriers trigger avalanche multiplication, and an avalanche multiplication current flows through the photon detection element 22. The flow of the avalanche multiplication current through the quenching element 24 causes a voltage drop across the quenching element 24, and the voltage at the node A starts to drop. The amount of voltage drop at the node A increases, and once the avalanche multiplication stops at time t3, the voltage level of the node A does not drop any further.

When the avalanche multiplication in the photon detection element 22 stops, a current to compensate for the voltage drop flows from the node to which the voltage VL is supplied to the node A via the photon detection element 22, and the voltage of the node A increases gradually. At time t5, the node A settles at its original voltage level.

The signal processing circuit 32 binarizes the signal input from the node A in accordance with a predetermined determination threshold, and outputs the resulting signal from the node B. Specifically, if the voltage level of the node A exceeds the determination threshold, the signal processing circuit 32 outputs a low-level signal from the node B. If the voltage level of the node A is lower than or equal to the determination threshold, the signal processing circuit 32 outputs a high-level signal from the node B. Suppose, for example, that the voltage of the node A is lower than or equal to the determination threshold during the period from time t2 to time t4 as illustrated in FIG. 5B. In such a case, as illustrated in FIG. 5C, the signal level of the node B is at a low level during the period from time t0 to time t2 and the period from the time t4 to time t5, and at a high level during the period from time t2 to time t4.

The waveform of the analog signal input from the node A is thus shaped into a digital signal by the signal processing circuit 32. The pulse signal output from the signal processing circuit 32 in response to the incidence of the photon on the photon detection element 22 is referred to as a photon detection pulse signal.

FIGS. 6A and 6B are diagrams for describing a configuration example and operation of the signal processing circuit 32. FIG. 6A is a circuit diagram illustrating the configuration example of the signal processing circuit 32. FIG. 6B illustrates the waveforms of the input signals (signals IN1 and IN2) and output signal (signal OUT) of the signal processing circuit 32.

For example, as illustrated in FIG. 6A, the signal processing circuit 32 can be constituted by a two-input NOR circuit including N-type transistors MNH1 and MNL1 and P-type transistors MPH1 and MPL1. The input node to which the signal IN1 is supplied is connected to the gate of the N-type transistor MNH1 and the gate of the P-type transistor MPH1. The input node to which the signal IN2 is supplied is connected to the gate of the N-type transistor MNL1 and the gate of the P-type transistor MPL1. The source of the P-type transistor MPH1 is connected to a power supply voltage node (voltage VDD). The drain of the P-type transistor MPH1 is connected to the source of the P-type transistor MPL1. The drain of the P-type transistor MPL1 is connected to the drain of the N-type transistor MNH1 and the drain of the N-type transistor MNL1. The source of the N-type transistor MNH1 and the source of the N-type transistor MNL1 are connected to a reference voltage node (voltage VSS). The connection node between the drain of the P-type transistor MPL1, the drain of the N-type transistor MNH1, and the drain of the N-type transistor MNL1 constitutes the output node of the signal processing circuit 32.

As illustrated in FIG. 6B, if the signal IN2 is at the low level, the signal processing circuit 32 of FIG. 6A constituted by the two-input NOR circuit outputs the photon detection pulse signal in response to the incidence of a photon on the photon detection element 22. On the other hand, if the signal IN2 is at the high level, the signal processing circuit 32 does not output the photon detection pulse signal even when a photon is incident on the photon detection element 22.

The signal processing circuit 32 of the photoelectric conversion apparatus 100 according to the present exemplary embodiment includes elements with relatively high withstand voltage (high withstand voltage transistors) and elements with relatively low withstand voltage (low withstand voltage transistors). Specifically, the N-type transistor MNH1 and the P-type transistor MPH1, which receive the signal IN1 at their control node (gate), are constituted by high withstand voltage transistors. The N-type transistor MNL1 and the P-type transistor MPL1, which receive the signal IN2 at their control node (gate), are constituted by low withstand voltage transistors. The high withstand voltage transistors can be 2.5-V rated transistors designed for operation with a power supply voltage of 2.5 V, for example. The low withstand voltage transistors can be 1.1-V rated transistors designed for operation with a power supply voltage of 1.1 V, for example.

The logic circuits constituting the counter 34 and the pixel output circuit 36 desirably include transistors capable of high-speed operation with low power consumption. Transistors having such characteristics are low withstand voltage transistors with a relatively low withstand voltage. On the other hand, the signal IN1 output from the photoelectric conversion unit 20 has a predetermined amplitude (first amplitude: voltage V1) corresponding to the operation of the photoelectric conversion unit 20. This voltage V1 is usually higher than the amplitude of the internal signals of the logic circuits (second amplitude: second voltage V2) and exceeds the withstand voltage of the gates of the low withstand voltage transistors. The low withstand voltage transistors are therefore unable to receive the signal IN1. The signal processing circuit 32 thus includes high withstand voltage transistors having a withstand voltage higher than the voltage V1.

However, high withstand voltage transistors occupy a large area compared to low withstand voltage transistors. Configuring the signal processing circuit 32 with only high withstand voltage transistors thus increases the circuit area. In particular, SPAD image sensors include a large number of elements per pixel compared to CMOS image sensors. The area of the signal processing circuit 32 is therefore desirably reduced as much as possible.

In the present exemplary embodiment, the N-type transistor MNH1 and the P-type transistor MPH1 to receive the signal IN1 are constituted by high withstand voltage transistors, and the N-type transistor MNL1 and the P-type transistors MPL1 to receive the signal IN2 are constituted by low withstand voltage transistors. Such a configuration minimizes the number of high withstand voltage transistors, and the signal processing circuit 32 to withstand the voltage V1 can be implemented in a small area. The element spacings can thereby be increased to reduce interference between signals. Alternatively, the number of elements built in the pixel 12 of the same area can be increased to enhance the functionality of the photoelectric conversion apparatus 100.

While FIGS. 6A and 6B illustrate an example where the signal processing circuit 32 is constituted by a two-input NOR circuit, the signal processing circuit 32 is not limited to a two-input NOR circuit. For example, as illustrated in FIGS. 7A and 7B, the signal processing circuit 32 may be constituted by a two-input one-output logic circuit including an inverter circuit and a NAND circuit. The signal processing circuit 32 illustrated in FIGS. 7A and 7B includes a NOT circuit (inverter circuit) including an N-type transistor MNH2 and a P-type transistor MPH2, and a NAND circuit including N-type transistors MNH1 and MNL1 and P-type transistors MPH1 and MPL1.

The input node to which the signal IN1 is supplied is connected to the gate of the N-type transistor MNH2 and the gate of the P-type transistor MPH2. The source of the P-type transistor MPH2 is connected to a power supply voltage node (voltage VDH). The drain of the P-type transistor MPH2 is connected to the drain of the N-type transistor MNH2. The source of the N-type transistor MNH2 is connected to the reference voltage node (voltage VSS). The connection node (node N1) between the drain of the P-type transistor MPH2 and the drain of the N-type transistor MNH2 serves as the output node of the inverter circuit. The signal amplitude at the node N1 has the voltage V1. The potential difference between the voltages VDH and VSS is substantially the same as the voltage V1.

The node N1 is connected to the gate of the N-type transistor MNH1 and the gate of the P-type transistor MPH1. The input node to which the signal IN2 is supplied is connected to the gate of the N-type transistor MNL1 and the gate of the P-type transistor MPL1. The source of the P-type transistor MPH1 and the source of the P-type transistor MPL1 are connected to the power supply voltage node (voltage VDD). The drain of the P-type transistor MPH1 and the drain of the P-type transistor MPL1 are connected to the drain of the N-type transistor MNH1. The source of the N-type transistor MNH1 is connected to the drain of the N-type transistor MNL1. The source of the N-type transistor MNL1 is connected to the reference voltage node (voltage VSS). The connection node between the drain of the P-type transistor MPH1, the drain of the P-type transistor MPL1, and the drain of the N-type transistor MNH1 constitutes the output node of the signal processing circuit 32.

As illustrated in FIG. 7B, if the signal IN2 is at the high level, the signal processing circuit 32 constituted by the circuit illustrated in FIG. 7A outputs the photon detection pulse signal in response to the incidence of a photon on the photon detection element 22. On the other hand, if the signal IN2 is at the low level, the signal processing circuit 32 does not output the photon detection pulse signal even when a photon is incident on the photon detection element 22.

The N-type transistors MNH1 and MNL1 and the P-type transistors MPH1 and MPL1 in FIG. 7A may be constituted by low withstand voltage transistors, and the voltage VDD may be supplied to the source of the P-type transistor MPH2 of the NOT circuit. While FIGS. 6A, 6B, 7A, and 7B illustrate a two-input signal processing circuit 32, the signal processing circuit 32 is not limited to a two-input configuration. The signal processing circuit 32 may have three or more input nodes.

FIG. 8 is a plan view illustrating a layout example of elements constituting the pixel unit 10 on the circuit substrate 120. FIG. 8 illustrates four pixels 12 arranged in two rows×two columns among the plurality of pixels 12 disposed on the pixel unit 10. The pixel unit 10 is constituted by repeatedly arranging a unit block including these four pixels 12 in the row direction and the column direction. For the sake of simplicity, FIG. 8 illustrates only a pattern of active regions, a pattern of gate layers, and a pattern of N-wells 134 and P-wells 136. The borders between the N-wells 134 and the P-wells 136 are illustrated in dotted lines. The regions of the P-wells 136 are filled with a dot pattern. The borders between the regions where the low withstand voltage transistors are disposed (low withstand voltage regions LV) and the regions where the high withstand voltage transistors are disposed (high withstand voltage regions HV) are indicated by dot-dashed lines.

The elements constituting the pixels 12 except for the photon detection elements 22, or namely, the quenching elements 24 and the transistors constituting the signal processing circuits 32, the counters 34, and the pixel output circuits 36 are disposed on the circuit substrate 120. In FIG. 8, corresponding reference symbols are denoted to the P-type transistors MPQ constituting the quenching elements 24, and the N-type transistors MNH1 and MNL1 and the P-type transistors MPH1 and MPL1 constituting the signal processing circuits 32. The other transistors without reference symbols are ones constituting the counters 34 and the pixel output circuits 36. While specific transistors are designated as the N-type transistors MNL1 and the P-type transistors MPL1 in FIG. 8, the N-type transistors MNL1 and the P-type transistors MPL1 are not limited in particular and may be any of the transistors disposed in the low withstand voltage regions LV.

Of the transistors constituting the quenching elements 24 and the signal processing circuits 32, the N-type transistors MNH1 and the P-type transistors MPH1 and MPQ (third elements) are high withstand voltage transistors. On the other hand, the N-type transistors MNL1 and the P-type transistors MPL1 are low withstand voltage transistors. The N-type transistors MNH1 and the P-type transistors MPH1 and MPQ are disposed in the high withstand voltage regions HV (first regions), and the N-type transistors MNL1 and the P-type transistors MPL1 are disposed in the low withstand voltage regions LV (second regions). The high withstand voltage transistors and the low withstand voltage transistors are spaced a predetermined distance apart in view of providing margins for misalignment due to the different manufacturing processes and ensuring withstand voltages.

In the layout example of FIG. 8, the four pixels 12 in two rows by two columns, are arranged in a mirror symmetrical manner so that the high withstand voltage regions HV of the four pixels 12 adjoin each other. In other words, a single region constituted by the high withstand voltage regions HV of the four pixels 12 is shared by the four pixels 12. This can reduce the border between the high withstand voltage region HV and the low withstand voltage region HL in each pixel 12 and improve the area efficiency. More complex circuits can thus be applied to the signal processing circuits 32, the counters 34, and the pixel output circuits 36 to further enhance the functionality of the photoelectric conversion apparatus 100.

FIG. 8 illustrates an example where two sides of a high withstand voltage region HV touch the high withstand voltage regions HV of adjoining pixels 12. However, the number of sides touching the high withstand voltage regions HV of adjoining pixels 12 may be one or three.

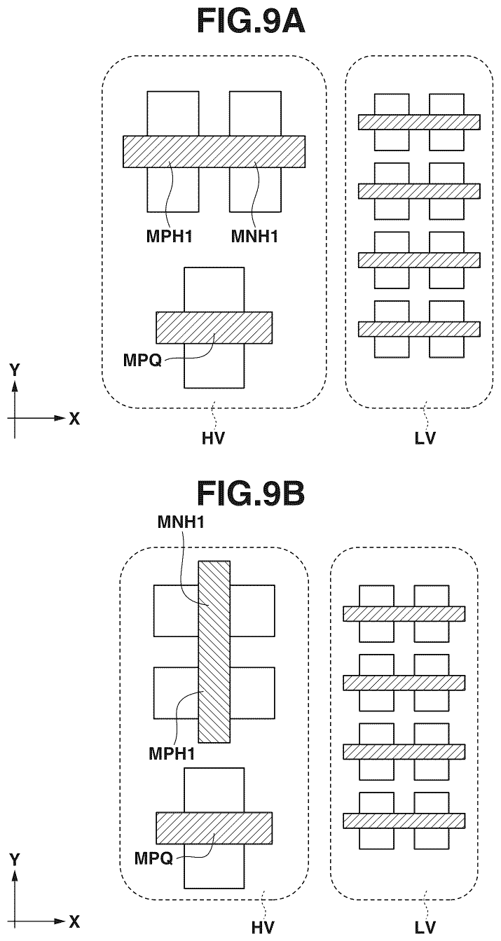

In the layout example of FIG. 8, the direction (X direction) in which the gate of the P-type transistor MPQ extends and the direction (Y direction) in which the gates of the N-type transistor MNH1 and the P-type transistor MPH1 extend are orthogonal to each other. Such a layout can possibly improve the area efficiency compared to a layout where the direction in which the gate of the P-type transistor MPQ extends and the direction in which the gates of the N-type transistor MNH1 and the P-type transistor MPH1 extend are the same (X direction) (see FIGS. 9A and 9B). The extending directions of the gates of the transistors can be selected as appropriate from the viewpoint of improving the area efficiency.

As illustrated in FIG. 8, the N-type transistor MNH1, which is a high withstand voltage transistor, and the N-type transistor MNL1, which is a low withstand voltage transistor, can be disposed in the same P-well 136. Similarly, the P-type transistors MPH1 and MPQ, which are high withstand voltage transistors, and the P-type transistor MPL1, which is a low withstand voltage transistor, can be disposed in the same N-well 134.

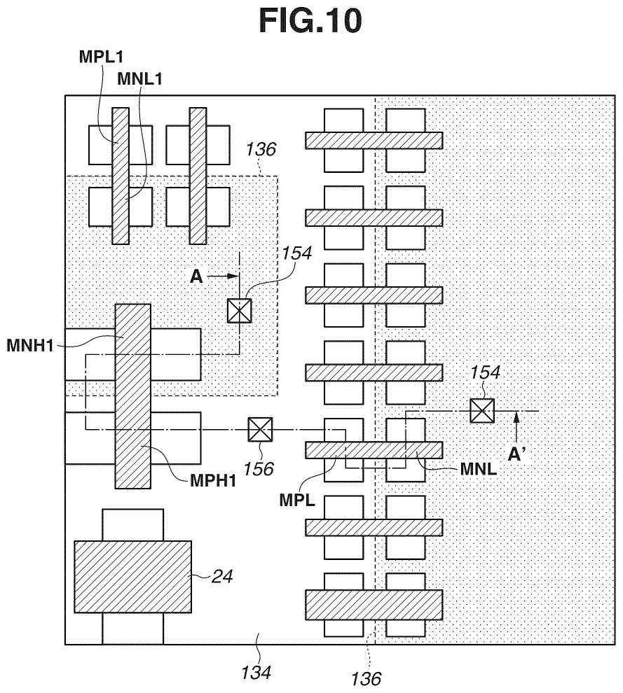

FIG. 10 is a plan view of some of the elements of a pixel 12 extracted from FIG. 8. FIG. 11 is a cross-sectional view taken along line A-A′ in FIG. 10. In FIGS. 10 and 11, an N-type transistor MNL is a low withstand voltage transistor having a structure similar to that of the N-type transistor MNL1. A P-type transistor MPL is a low withstand voltage transistor having a structure similar to that of the P-type transistor MPL1.

In the surface portion of a silicon substrate 130, an N-well 134 and P-wells 136 are disposed. In the surface portion of the silicon substrate 130, element isolation regions 132 for defining active regions are also disposed. The N-type transistor MNH1, MNL1, and MNL and P-well contact portions 154 are disposed in the active regions defined in the P-wells 136. The P-type transistors MPH1, MPL1, and MPL and an N-well contact portion 156 are disposed in the active regions defined in the N-well 134. The N-well 134 may be configured as a double-well structure surrounded by a P-type region so that the N-well 134 is electrically isolated from the deep region of the silicon substrate 130.

The N-type transistors MNL1 and MNL each include a gate electrode 146 located on the silicon substrate 130 via a gate insulating film 142, and source/drain regions 150 formed of N-type semiconductor regions. The P-type transistors MPL1 and MPL each include a gate electrode 146 located on the silicon substrate 130 via a gate insulating film 142, and source/drain regions 152 formed of P-type semiconductor regions. The N-type transistor MNH1 includes a gate electrode 148 located on the silicon substrate 130 via a gate insulating film 144, and source/drain regions 150 formed of N-type semiconductor regions. The P-type transistor MPH1 includes a gate electrode 148 located on the silicon substrate 130 via a gate insulating film 144, and source/drain regions 152 formed of P-type semiconductor regions.

The high withstand voltage N-type transistor MNH1 and the low withstand voltage N-type transistor MNL1 share a P-well contact portion 154. The P-well contact portion 154 is constituted by a heavily doped P-type semiconductor region disposed in the surface portion of the P-well 136. The high withstand voltage P-type transistor MPH1 and the low withstand voltage P-type transistors MPL1 and MPL share the N-well contact portion 156. The N-well contact portion 156 is constituted by a heavily doped N-type semiconductor region disposed in the surface portion of the N-well 134.

The low withstand voltage transistors (N-type transistors MNL1 and MNL and P-type transistors MPL1 and MPL) and the high withstand voltage transistors (N-type transistor MNH1 and P-type transistor MPH1) include the gate insulating films 142 and 144 of different thicknesses. Specifically, the gate insulating films 144 of the high withstand voltage transistors have a thickness greater than that of the gate insulating films 142 of the low withstand voltage transistors.

Next, an example of a method for manufacturing the low withstand voltage transistors and the high withstand voltage transistors will be described with reference to FIGS. 12A to 12C and FIGS. 13A to 13C. FIGS. 12A to 12C and FIGS. 13A to 13C are cross-sectional process diagrams illustrating the method for manufacturing the low withstand voltage transistors and the high withstand voltage transistors.

Initially, element isolation regions 132 for defining active regions are formed in the surface portion of the silicon substrate 130 using shallow trench isolation (STI) method, for example.

Next, predetermined impurities are injected into predetermined regions of the silicon substrate 130 to form the N-well 134 and the P-wells 136 by using photolithography and ion injection (FIG. 12A).

Next, the silicon substrate 130 is thermally oxidized by thermal oxidation, for example, whereby a silicon oxide film 138 is formed in the surface portions of the active regions defined by the element isolation regions 132 (FIG. 12B).

Next, a photoresist film 140 that covers at least the high withstand voltage region HV and exposes at least the low withstand voltage region LV is formed by using photolithography.

Next, the silicon oxide film 138 is etched using the photoresist film 140 as a mask, whereby the silicon oxide film 138 in the low withstand voltage region LV is removed (FIG. 12C). In FIG. 12C, the silicon oxide film 138 on the well contact regions is also removed with the silicon oxide film 138 on the low withstand voltage region LV. However, the silicon oxide film 138 on the well contact regions does not necessarily need to be removed.

Next, the photoresist film 140 is removed by ashing, for example.

Next, the silicon substrate 130 is thermally oxidized by thermal oxidation, for example, whereby a silicon oxide film having a first thickness (gate insulating film 142) is formed in the low withstand voltage region LV and the well contact regions. At the same time, the silicon oxide film 138 in the high withstand voltage region HV is additionally oxidized to form a silicon oxide film having a second thickness greater than the first thickness (gate insulating film 144) (FIG. 13A).

Next, a polycrystalline silicon film is deposited by chemical vapor deposition (CVD), for example. The polycrystalline silicon film is then patterned by photolithography and dry etching, whereby the gate electrodes 146 and 148 are formed (FIG. 13B).

Next, N-type impurities are injected into N-type transistor forming regions and the N-well contact region using photolithography and ion injection. The source/drain regions 150 of the N-type transistors MNH1, MNL1, and MNL and the N-well contact portion 156 are thereby formed.

P-type impurities are injected into P-type transistor formation regions and the P-well contact regions using photolithography and ion injection. The source/drain regions 152 of the P-type transistors MPH1, MPL1, and MPL and the P-well contact portions 154 are thereby formed (FIG. 13C).

According to the present exemplary embodiment, the area efficiency of the elements constituting the pixel circuits can thus be improved to enhance the performance or functionality of the photoelectric conversion apparatus.

### Modification of First Exemplary Embodiment

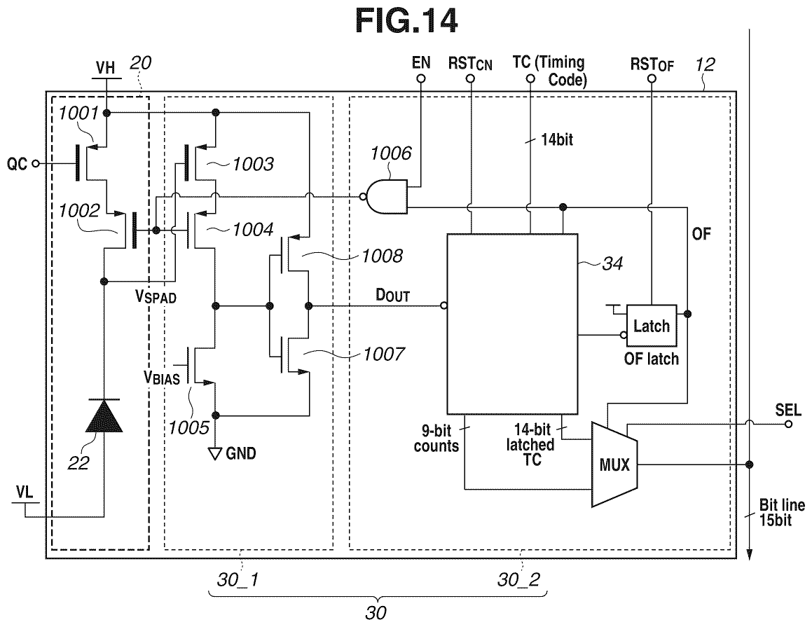

A modification of the first exemplary embodiment of the present invention will be described with reference to FIG. 14. FIG. 14 is a block diagram illustrating a configuration example of a pixel of the photoelectric conversion apparatus according to the present exemplary embodiment. In FIG. 14, parts denoted by the same reference numerals as in FIG. 3 provide functions similar to those in FIG. 3.

In the present exemplary embodiment, a photoelectric conversion apparatus that implements high dynamic range (HDR) processing for expanding the dynamic range will be described. In a high illuminance environment, the photoelectric conversion apparatus including the counters for counting the output signals from the APDs counts an enormous number of times and increases in power consumption. In the present exemplary embodiment, the photoelectric conversion apparatus therefore counts normally in a low illuminance environment. In a high illuminance environment, the APDs are stopped when a predetermined count value is reached (when the counters overflow). The photoelectric conversion apparatus extrapolates the count numbers based on code corresponding to the timing of overflow (overflow timing code). The resulting signals are then combined to obtain an image. Such a configuration can reduce the scale of the counters, and an HDR photoelectric conversion apparatus with pixel circuits of reduced space and low power consumption can be provided.

In FIG. 14, the pixel 12 of the photoelectric conversion apparatus includes a photoelectric conversion unit 20 and a pixel signal processing unit 30. The photoelectric conversion unit 20 includes a photon detection element 22, a transistor 1001 corresponding to a quenching element 24, and a transistor 1002. The transistor 1002 functions as a switch for switching whether to supply a reserve bias voltage for avalanche multiplication to the photon detection element 22. The pixel signal processing unit 30 includes a buffer section 30_1 and a counter and control logic section 30_2. The buffer section 30_1 includes an inverter circuit constituted by transistors 1007 and 1008.

### (Details of Counting Operation)

The counter and control logic section 30_2 includes a logic circuit 1006. The logic circuit 1006 outputs a signal based on an enable (EN) signal and an overflow (OF) signal. Specifically, the output signal of the logic circuit 1006 is at a low (L) level when the EN signal is at a high (H) level and the OF signal is at a H level. Since the output signal from the logic circuit 1006 is at the L level, the transistors 1002 and 1004 turn on. With the gate input QC of the transistor 1001 at a L level, the transistor 1001 turns on. This recharges the voltage of a signal V_{SPAD} with the voltage VH, and the photon detection element 22 enters a standby state. When a photon is incident on the photon detection element 22 and an avalanche current occurs, the voltage of the signal V_{SPAD} decreases and the transistor 1003 is turned on. As a result, the input voltage of the inverter circuit changes to the H level via the transistor 1003 that is turned on and the transistor 1004 that is on. The gate input QC is fixed to the low level, and the voltage of the signal V_{SPAD} is immediately recharged (passive recharge). The recharged voltage of the signal V_{SPAD} turns the transistor 1003 off, and the input voltage of the inverter circuit changes to the ground (GND) level via the transistor 1005. In other words, the input voltage of the inverter circuit is lowered from the H level to the L level. Since the input of the inverter circuit is set to the H level by the photon incidence and then lowered to the L level, a pulse signal is output from an output Dour of the inverter circuit, and the counter 34 increments the count by one. The counter 34 counts up by repeating such an operation.

### (Differences in Operation Under Different Environments)

In a low illuminance environment, the counter 34 can finish counting without saturation within an exposure period. For example, if the counter 34 is a 9-bit counter, the count value without saturation is less than 512. In such a case, the count value of the counter 34 is output, after the exposure, to a bit line (for example, 15-bit line) via a multiplexer MUX at timing when a SEL signal is input. The signal output to the bit line is transmitted to a sense amplifier.

By contrast, in a high illuminance environment, the counter 34 saturates during an exposure period. For example, when the most significant bit of the counter 34 carries over, an OF flag is held in an overflow latch (OF latch). In such a case, the OF signal that is the output of the OF latch changes from the H level to the L level. Since the EN signal that is one of the input signals of the logic circuit 1006 is at the H level and the OF signal is at the L level, the output of the logic circuit 1006 transitions from the L level to the H level. This switches the transistors 1002 and 1004 from on to off. With the transistor 1002 off, the voltage of the signal V_{SPAD} is not recharged and an avalanche multiplication operation does not occur. With the transistor 1004 off, the input of the inverter circuit is set to the L level regardless of the voltage of the signal V_{SPAD}, whereby the buffer section 30_1 is initialized. The exposure period is thereby ended.

Meanwhile, timing code TC is input to the counter 34 from outside. The timing code TC is latched (recorded) at timing when the most significant bit of the counter 34 carries over. The latched timing code TC (e.g., 14 bits) output from the counter 34 and the OF flag are output to the bit line via the multiplexer MUX. The timing code TC is time information about the period from the start of exposure to the saturation of the counter 34.

Before the start of the next exposure period, the counter 34 is reset by a reset signal RST_{CN}. The OF latch is reset by a reset signal RST_{OF}.

In the foregoing description, the counter 34 is assumed to count up to the most significant bit. However, the counter 34 does not necessarily need to be used up to the most significant bit, and the timing code TC may be latched when the count value of the counter 34 reaches a predetermined value. In other words, the timing code TC may be time information about the period from the start of exposure to when the counter 34 reaches the predetermined value.

### (Types of Transistors)

The transistors 1001 and 1002 are disposed between the voltage VH and the voltage VL and are electrically connected to a high potential difference that is a difference between the voltage VH and the voltage VL. The transistors 1001 and 1002 are therefore constituted by high withstand voltage transistors.

The signal V_{SPAD} output from the photoelectric conversion unit 20 has a predetermined amplitude (voltage V1) corresponding to the operation of the photoelectric conversion unit 20. The voltage V1 is usually higher than the amplitude (voltage V2) of the internal signals of the logic circuits. To ensure the withstand voltage, the transistor 1003 is thus constituted by a high withstand voltage transistor.

By contrast, the buffer section 30_1 is a circuit corresponding to the signal processing circuit 32 in FIG. 3. The signal IN1in FIG. 3 corresponds to the signal V_{SPAD} in FIG. 14, and the signal IN2 in FIG. 3 corresponds to the output signal from the logic circuit 1006 in FIG. 14. The amplitude (voltage V2) of the signal input to the gate of the transistor 1004, i.e., the amplitude of the output signal from the logic circuit 1006 is thus smaller than the predetermined amplitude (voltage V1) corresponding to the operation of the photoelectric conversion unit 20. The transistor 1004 can thereby be a low withstand voltage transistor capable of high-speed operation with low power consumption. In other words, the signal processing circuit 32 (buffer section 30_1) includes a first element (transistor 1003) having a first withstand voltage and a second element (transistor 1004) having a second withstand voltage lower than the first withstand voltage. The signal processing circuit 32 (buffer section 30_1) is configured such that a first signal (signal V_{SPAD}) is input to the first element and a second signal (signal from the logic circuit 1006) is input to the second element. The signal processing circuit 32 (buffer section 30_1) controls the output of a third signal (output signal from the inverter circuit) based on the first signal (signal V_{SPAD}) and the second signal (signal from the logic circuit 1006).

In addition, the transistors constituting the buffer section 30_1 except for the transistor 1003 can be configured as low withstand voltage transistors. Specifically, the transistors 1005, 1007, and 1008 are configured as low withstand voltage transistors.

The specific configuration of the low and high withstand voltage transistors according to this modification can be similar to that of the exemplary embodiment described above.

### (Driving Timing Chart Etc.)

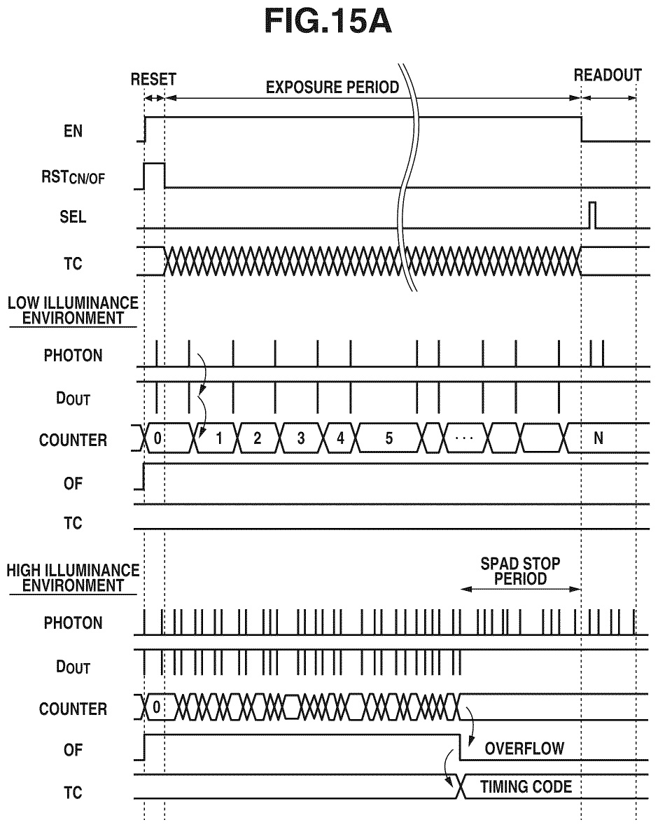

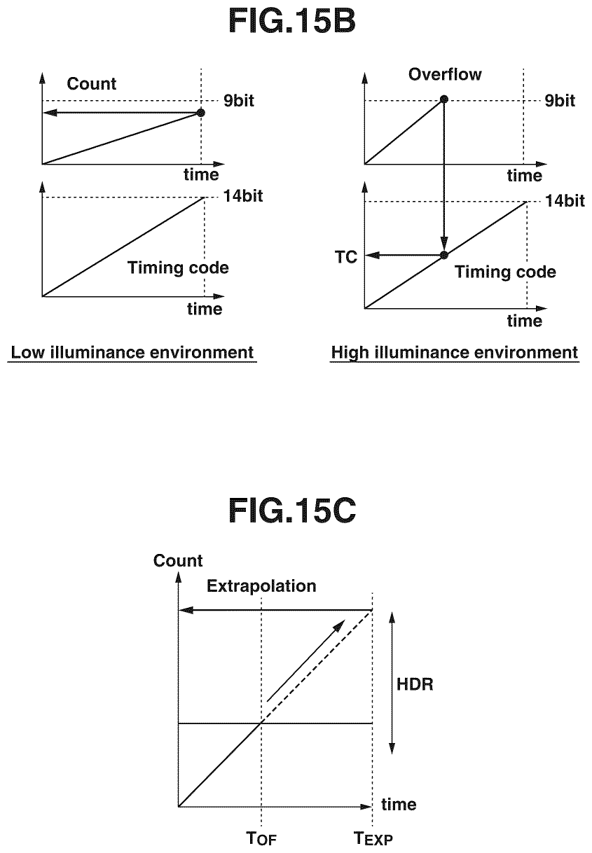

The upper part of FIG. 15A is a timing chart. The reset signal RST_{CN} and the reset signal RST_{OF} transition from the L level to the H level at timing when the EN signal transitions from the L level to the H level, and then transition from the H level to the L level. The counter 34 and the OF latch are thereby reset. The OF signal transitions from the L level to the H level at the timing when the EN signal transitions from the L level to the H level. When the resetting is completed, the exposure period starts and the timing code TC starts to be counted.

The middle part of FIG. 15A is a diagram illustrating an operation in a low illuminance environment. When a photon is incident, a pulse signal Dour is output and the counter 34 counts up. Since the most significant bit of the counter 34 does not carry over, the OF flag is maintained at the H level.

The lower part of FIG. 15A is a diagram illustrating an operation in a high illuminance environment. Since the most significant bit of the counter 34 carries over to overflow, the OF flag transitions from the H level to the L level. The timing code TC is thereby latched.

In the low illuminance environment of FIG. 15B, the counter 34 does not overflow, and thus the count value itself is simply used as the count value. By contrast, in the high illuminance environment, the counter 34 overflows and the value of the timing code at the time of the overflow is latched.

FIG. 15C is a diagram illustrating the signal processing in the case where the counter 34 overflows. Since the counter 34 overflows at time Tor, a predicted count value is calculated from the value of the timing code TC, and the calculated predicted count value is used as the numerical value for image formation. More specifically, the predicted count value is extrapolated from the value of the timing code TC. Instead of calculating the predicted count value from the value of the timing code TC each time, a table defining the correspondence between the value of the timing code TC and the predicted count value may be prepared in advance, and the predicted count value may be acquired from the value of the timing code TC without calculation.

An acquisition unit that acquires the predicted count value based on the value of the timing code TC (time information about when the count value reaches a predetermined value) may be included in the photoelectric conversion apparatus 100. Alternatively, the acquisition unit may be implemented outside the photoelectric conversion apparatus 100 as an acquisition apparatus for acquiring the predicted count value.

### Second Exemplary Embodiment

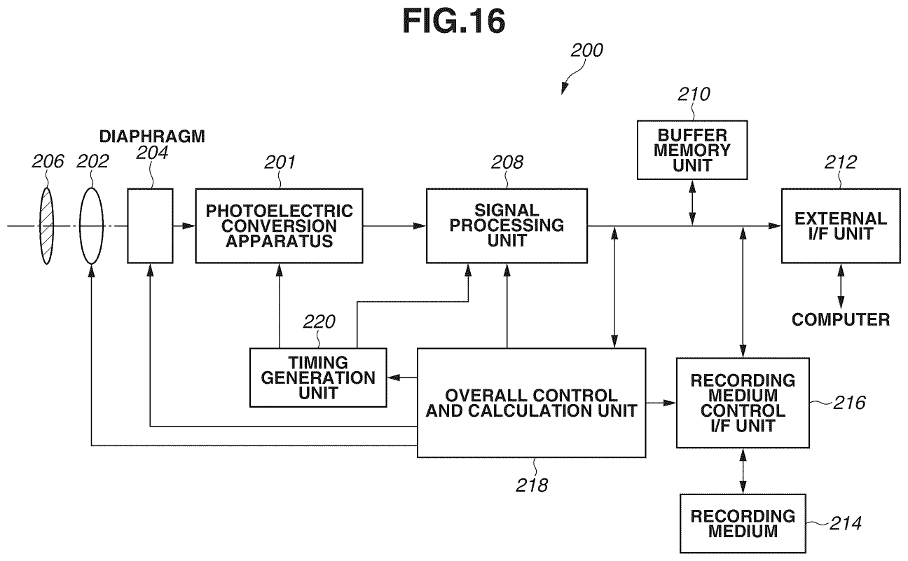

An optical detection system according to a second exemplary embodiment of the present invention will be described with reference to FIG. 16. FIG. 16 is a block diagram illustrating a schematic configuration of the optical detection system according to the present exemplary embodiment. In the present exemplary embodiment, an optical detection sensor will be described to which the photoelectric conversion apparatus 100 according to the first exemplary embodiment is applied.

The photoelectric conversion apparatus 100 described in the foregoing first exemplary embodiment can be applied to various optical detection systems. Examples of the applicable optical detection systems include imaging systems, such as digital still cameras, digital camcorders, surveillance cameras, copying machines, facsimiles, mobile phones, on-vehicle cameras, and observation satellites. Camera modules including an optical system, such as a lens, and an imaging device are also included in the optical detection systems. FIG. 16 illustrates a block diagram of a digital still camera as an example of these.

An optical detection system 200 illustrated in FIG. 16 includes a photoelectric conversion apparatus 201, a lens 202 for forming an optical image of an object on the photoelectric conversion apparatus 201, a diaphragm 204 for adjusting the amount of light passing through the lens 202, and a barrier 206 for protecting the lens 202. The lens 202 and the diaphragm 204 are an optical system for collecting light to the photoelectric conversion apparatus 201. The photoelectric conversion apparatus 201 is the photoelectric conversion apparatus 100 described in the first exemplary embodiment, and converts the optical image formed by the lens 202 into image data.

The optical detection system 200 also includes a signal processing unit 208 that processes an output signal from the photoelectric conversion apparatus 201. The signal processing unit 208 generates image data from a digital signal output from the photoelectric conversion apparatus 201. The signal processing unit 208 performs an operation for making various types of correction and compression as appropriate and outputting the image data. The photoelectric conversion apparatus 201 can include an analog-to-digital (AD) conversion unit that generates the digital signal to be processed in the signal processing unit 208. The AD conversion unit may be formed on the semiconductor layer (semiconductor substrate) where the photon detection elements of the photoelectric conversion apparatus 201 are formed, or on a semiconductor substrate different from the semiconductor layer where the photon detection elements of the photoelectric conversion apparatus 201 are formed. The signal processing unit 208 may be formed on the same semiconductor substrate as that of the photoelectric conversion apparatus 201.

The optical detection system 200 further includes a buffer memory unit 210 for temporarily storing the image data, and an external interface (I/F) unit 212 for communicating with an external computer. The optical detection system 200 further includes a recording medium 214 for recording or reading captured data, such as a semiconductor memory, and a recording medium control I/F unit 216 for recording or reading the captured data on/from the recording medium 214. The recording medium 214 may be built in the optical detection system 200 or detachably attachable to the optical detection system 200. The communication between the recording medium control I/F unit 216 and the recording medium 214 and the communication from the external I/F unit 212 may be wirelessly performed.

The optical detection system 200 further includes an overall control and calculation unit 218 that controls various calculations and the entire digital still camera, and a timing generation unit 220 that outputs various timing signals to the photoelectric conversion apparatus 201 and the signal processing unit 208. The timing signals may be input from outside. The optical detection system 200 can include at least the photoelectric conversion apparatus 201 and the signal processing unit 208 for processing the output signal output from the photoelectric conversion apparatus 201. The timing generation unit 220 may be incorporated in the photoelectric conversion apparatus 201. The overall control and calculation unit 218 and the timing generation unit 220 may also be configured to implement some or all of the control functions of the photoelectric conversion apparatus 201.

The photoelectric conversion apparatus 201 outputs a captured signal to the signal processing unit 208. The signal processing unit 208 performs predetermined signal processing on the captured signal output from the photoelectric conversion apparatus 201 and outputs image data. The signal processing unit 208 generates an image by using the captured signal. The signal processing unit 208 may be configured to perform distance measurement calculation on the signal output from the photoelectric conversion apparatus 201.

As described above, according to the present exemplary embodiment, an optical detection system capable of acquiring images of high quality can be implemented by configuring the optical detection system by using the photoelectric conversion apparatus 100 according to the first exemplary embodiment.

### Third Exemplary Embodiment

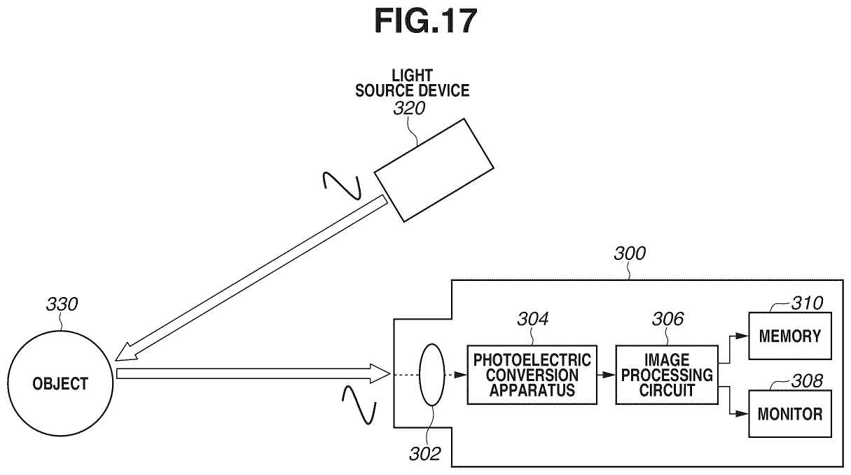

A distance image sensor according to a third exemplary embodiment of the present invention will be described with reference to FIG. 17. FIG. 17 is a block diagram illustrating a schematic configuration of the distance image sensor according to the present exemplary embodiment. In the present exemplary embodiment, the distance image sensor will be described as an example of an optical detection system to which the photoelectric conversion apparatus 100 according to the first exemplary embodiment is applied.

As illustrated in FIG. 17, a distance image sensor 300 according to the present exemplary embodiment can include an optical system 302, a photoelectric conversion apparatus 304, an image processing circuit 306, a monitor 308, and a memory 310. This distance image sensor 300 receives light (modulated light or pulsed light) emitted from a light source device 320 toward an object 330 and reflected on the surface of the object 330 and obtains a distance image in accordance with the distance to the object 330.

The optical system 302 includes one or more lenses and has a function of focusing image light (incident light) from the object 330 on the light reception surface (sensor unit) of the photoelectric conversion apparatus 304.

The photoelectric conversion apparatus 304 is the photoelectric conversion apparatus 100 described in the first exemplary embodiment. The photoelectric conversion apparatus 304 has a function of generating a distance signal indicating the distance to the object 330 based on the image light from the object 330 and supplying the generated distance signal to the image processing circuit 306.

The image processing circuit 306 has a function of performing image processing for constructing a distance image based on the distance signal supplied from the photoelectric conversion apparatus 304.

The monitor 308 has a function of displaying the distance image (image data) obtained by the image processing of the image processing circuit 306. The memory 310 has a function of storing (recording) the distance image (image data) obtained by the image processing of the image processing circuit 306.

As describe above, according to the present exemplary embodiment, a distance image sensor capable of obtaining a distance image including more accurate distance information can be achieved by configuring the distance image sensor using the photoelectric conversion apparatus 100 according to the first exemplary embodiment, together with the improvement in the characteristics of the pixels 12.

### Fourth Exemplary Embodiment

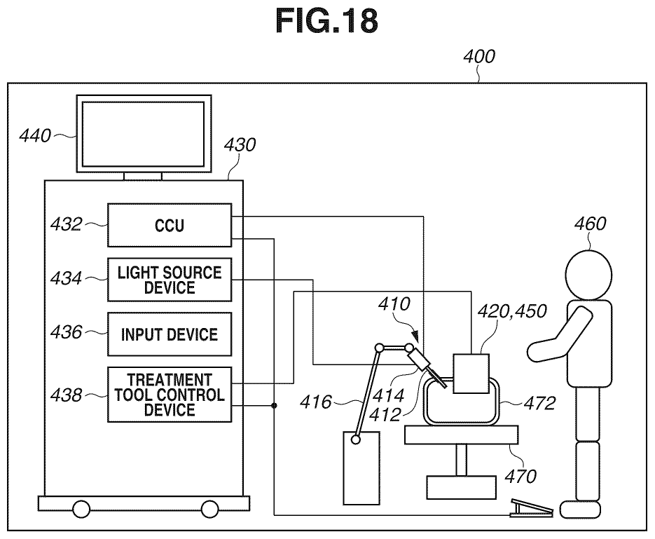

An endoscopic surgery system according to a fourth exemplary embodiment of the present invention will be described with reference to FIG. 18. FIG. 18 is a schematic diagram illustrating a configuration example of the endoscopic surgery system according to the present exemplary embodiment. In the present exemplary embodiment, the endoscopic surgery system will be described as an example of an optical detection system to which the photoelectric conversion apparatus 100 according to the first exemplary embodiment is applied.

FIG. 18 illustrates a state where an operator (doctor) 460 is performing surgery on a patient 472 on a patient bed 470 using an endoscopic surgery system 400.

As illustrated in FIG. 18, the endoscopic surgery system 400 according to the present exemplary embodiment can include an endoscope 410, a surgical tool 420, and a cart 430 on which various devices for endoscopic surgery are mounted. The cart 430 can mount a camera control unit (CCU) 432, a light source device 434, an input device 436, a treatment tool control device 438, and a display device 440.

The endoscope 410 includes a lens barrel 412 and a camera head 414. A predetermined length of the lens barrel 412 at the tip is inserted into a body cavity of the patient 472. The camera head 414 is connected to the bottom of the lens barrel 412. While FIG. 18 illustrates the endoscope 410 configured as a rigid scope with the rigid lens barrel 412, the endoscope 410 may be configured as a flexible scope with a flexible lens barrel. The endoscope 410 is moveably held by an arm 416.

The tip of the lens barrel 412 has an opening with an objective lens fitted thereto. The light source device 434 is connected to the endoscope 410. Light generated by the light source device 434 is guided to the tip of the lens barrel 412 by a lightguide extended through inside the lens barrel 412 and emitted toward an observation target in the body cavity of the patient 472 through the objective lens. The endoscope 410 may be a forward-viewing endoscope, an oblique-viewing endoscope, or a side-viewing endoscope.

Inside the camera head 414, a not-illustrated optical system and photoelectric conversion apparatus are disposed. Reflected light (observation light) from the observation target is collected to the photoelectric conversion apparatus through the optical system. The photoelectric conversion apparatus photoelectrically converts the observation light to generate an electrical signal corresponding to the observation light, or equivalently, an image signal corresponding to an observation image. The photoelectric conversion apparatus 100 described in the first exemplary embodiment can be used as the photoelectric conversion apparatus. The image signal is transmitted to the CCU 432 as raw data.

The CCU 432 includes a central processing unit (CPU) and a graphics processing unit (GPU) and controls the operation of the endoscope 410 and the display device 440 in a centralized manner. The CCU 432 also receives the image signal from the camera head 414 and performs various types of image processing for displaying an image based on the image signal, such as development processing (demosaicing processing), to the image signal.

The display device 440 displays the image based on the image signal to which the image processing is applied by the CCU 432, under control of the CCU 432.

The light source device 434 includes a light source, such as a light-emitting diode (LED), for example, and supplies the endoscope 410 with illumination light in capturing an image of the surgical site.

The input device 436 is an input I/F for the endoscopic surgery system 400. The user (operator) can input various types of information and instructions to the endoscopic surgery system 400 via the input device 436.

The treatment tool control device 438 controls driving of an energy treatment tool 450 for tissue cauterization, cutting, or sealing of blood vessels.

The light source device 434 that supplies the endoscope 410 with the illumination light in capturing an image of the surgical site can include a white light source including an LED, a laser light source, or a combination of these, for example. If the white light source is constituted by combining red, blue, and green (RGB) laser light sources, the white balance of the captured image can be adjusted by the light source device 434 since the output intensity and output timing of each color (wavelength) can be controlled with high precision. In such a case, images corresponding to the R, G, and B colors can be captured in a time-division manner by irradiating the observation target with the respective laser beams from the RGB laser light sources in a time-division manner and controlling the driving of the imaging elements of the camera head 414 in synchronization with the irradiation timing. According to such a method, a color image can be obtained without providing color filters on the imaging elements.

The driving of the light source device 434 can be controlled such that the intensity of the output light changes at a predetermined time interval. It is possible to generate an HDR image with no underexposure or overexposure by controlling the driving of the imaging elements of the camera head 414 in synchronization with the changing timing of the light intensity to obtain images in a time-division manner and combining the images.

The light source device 434 may be configured such that light in a predetermined wavelength band for special light observation can be supplied. For example, special light observation uses the wavelength dependence of light absorption by body tissues. Specifically, the light source device 434 captures a high-contrast image of predetermined tissues, such as blood vessels in the mucosal surface layer, by irradiating the mucosal surface layer with narrow-band light compared to the illumination light used in normal observation (i.e., white light). As another example of special light observation, fluorescence observation may be performed to obtain images based on fluorescence caused by excitation light irradiation. Fluorescence observation can obtain fluorescent images by irradiating body tissues with excitation light and observing fluorescence from the body tissues, or by locally injecting a reagent such as indocyanine green (ICG) into the body tissues and irradiating the body tissues with excitation light corresponding to the fluorescence wavelength of the reagent. The light source device 434 can be configured to be capable of supplying narrow-band light and/or excitation light for such special light observation.

As described above, according to the present exemplary embodiment, an endoscopic surgery system capable of obtaining images of higher quality can be implemented by configuring the endoscopic surgery system by using the photoelectric conversion apparatus 100 according to the first exemplary embodiment.

### Fifth Exemplary Embodiment

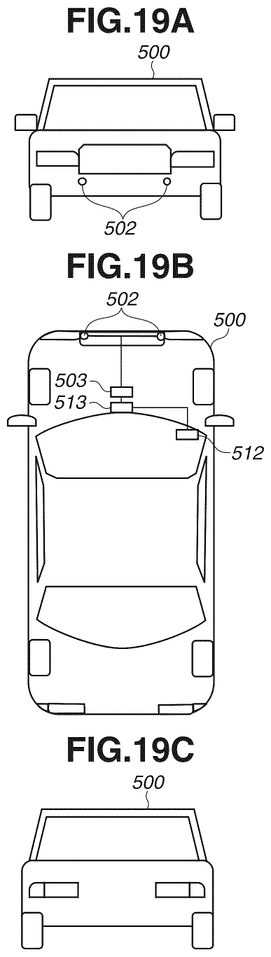

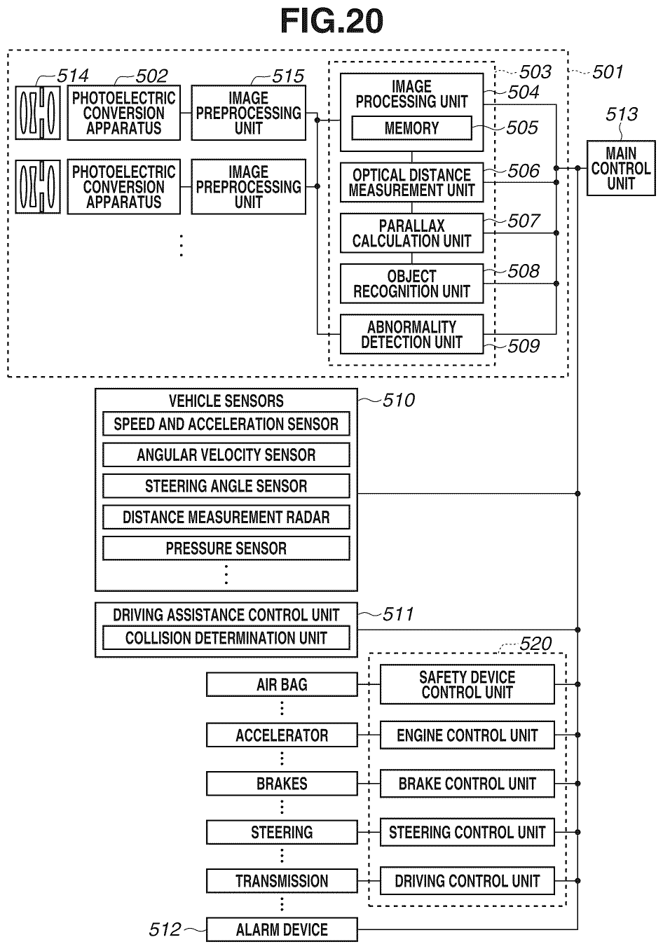

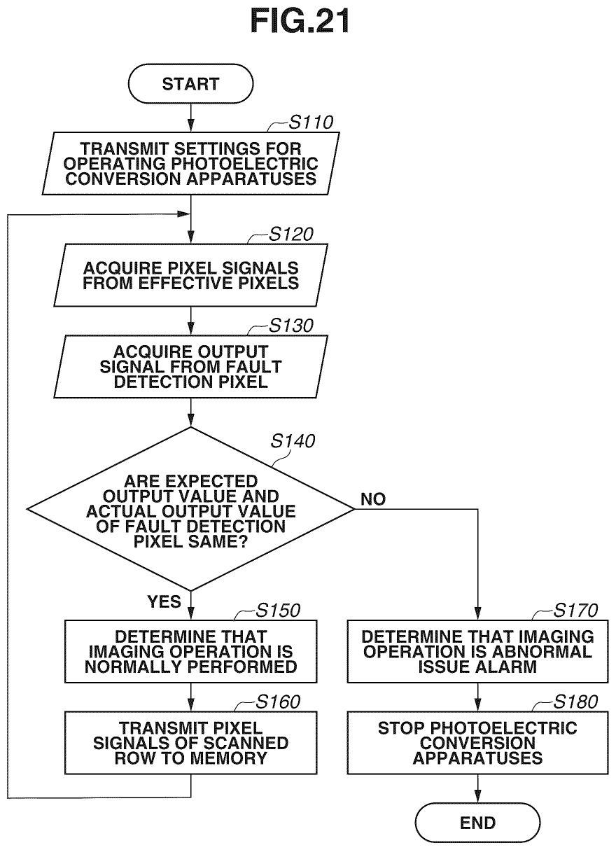

An optical detection system and a moving body according to a fifth exemplary embodiment of the present invention will be described with reference to FIGS. 19A to 21. FIGS. 19A to 19C are schematic diagrams illustrating a configuration example of the moving body according to the present exemplary embodiment. FIG. 20 is a block diagram illustrating a schematic configuration of the optical detection system according to the present exemplary embodiment. FIG. 21 is a flowchart illustrating an operation of the optical detection system according to the present exemplary embodiment. In the present exemplary embodiment, an on-vehicle camera will be described as an example of application of an optical detection system to which the photoelectric conversion apparatus 100 of the first exemplary embodiment is applied.

FIGS. 19A to 19C are schematic diagrams illustrating the configuration example of the moving body (vehicle system) according to the present exemplary embodiment. FIGS. 19A to 19C illustrate a configuration of a vehicle 500 (automobile) as an example of the vehicle system incorporating the optical detection system to which the photoelectric conversion apparatus 100 according to the first exemplary embodiment is applied. FIG. 19A is a schematic front view of the vehicle 500. FIG. 19B is a schematic plan view of the vehicle 500. FIG. 19C is a schematic rear view of the vehicle 500. The vehicle 500 includes a pair of photoelectric conversion apparatuses 502 on the front. Each of the photoelectric conversion apparatuses 502 is the photoelectric conversion apparatus 100 described in the first exemplary embodiment. The vehicle 500 also includes an integrated circuit 503, an alarm device 512, and a main control unit 513.

FIG. 20 is a block diagram illustrating a configuration example of an optical detection system 501 mounted on the vehicle 500. The optical detection system 501 includes the photoelectric conversion apparatuses 502, image preprocessing units 515, the integrated circuit 503, and optical systems 514. Each of the photoelectric conversion apparatuses 502 is the photoelectric conversion apparatus 100 described in the first exemplary embodiment. The optical systems 514 form optical images of an object on the photoelectric conversion apparatuses 502. The photoelectric conversion apparatuses 502 convert the optical images of the object formed by the optical systems 514 into electrical signals. The image preprocessing units 515 perform predetermined signal processing on the signals output from the photoelectric conversion apparatuses 502. The functions of the image preprocessing units 515 may be built in the photoelectric conversion apparatuses 502. The optical detection system 501 includes at least two sets of an optical system 514, a photoelectric conversion apparatus 502, and an image preprocessing unit 515. The output of the image preprocessing unit 515 in each set is input to the integrated circuit 503.

The integrated circuit 503 is used for imaging system applications, and includes an image processing unit 504, an optical distance measurement unit 506, a parallax calculation unit 507, an object recognition unit 508, and an abnormality detection unit 509. The image processing unit 504 processes image signals output from the image preprocessing units 515. For example, the image processing unit 504 performs image processing, such as development processing and defect correction, on the output signals of the image preprocessing units 515. The image processing unit 504 includes a memory 505 for temporarily storing the image signals. The memory 505 can store the positions of known defective pixels in the photoelectric conversion apparatuses 502, for example. The optical distance measurement unit 506 performs focusing and distance measurement on the object. The parallax calculation unit 507 calculates distance measurement information (distance information) from a plurality of pieces of image data (parallax images) obtained by the plurality of photoelectric conversion apparatuses 502. Each of the photoelectric conversion apparatuses 502 may include a configuration capable of obtaining various types of information, such as distance information. The object recognition unit 508 recognizes objects, such as cars, roads, road signs, and people. If an abnormality of the photoelectric conversion apparatuses 502 is detected, the abnormality detection unit 509 notifies the main control unit 513 of the abnormality.

The integrated circuit 503 may be implemented by dedicatedly designed hardware, by software modules, or by a combination of these. A field programmable gate array (FPGA) or an application specific integrated circuit (ASIC) may be used for implementation. The integrated circuit 503 may be implemented by a combination of these.

The main control unit 513 supervises and controls the operation of the optical detection system 501, vehicle sensors 510, and control units 520. The vehicle 500 does not necessarily need to include the main control unit 513. In such a case, the photoelectric conversion apparatuses 502, the vehicle sensors 510, and the control units 520 transmit and receive control signals via a communication network. For example, a control area network (CAN) standard can be applied to the transmission and reception of the control signals.

The integrated circuit 503 has a function of transmitting control signals and setting values to the photoelectric conversion apparatuses 502 by receiving control signals from the main control unit 513 or on the initiative of its own control unit.

The optical detection system 501 is connected to the vehicle sensors 510, and can detect the vehicle's own driving state, such as a vehicle speed, yaw rate, and steering angle, as well as the environment outside the vehicle and the state of other vehicles and obstacles. The vehicle sensors 510 also serve as a distance information acquisition unit for acquiring information about a distance to a target object. Moreover, the optical detection system 501 is connected to a driving assistance control unit 511 that performs various types of driving assistance, such as automatic steering, automatic cruising, and collision avoidance functions. In particular, as a collision determination function, the driving assistance control unit 511 determines collision estimation and the presence or absence of a collision with other vehicles and obstacles based on the detection results of the optical detection system 501 and the vehicle sensors 510. The driving assistance control unit 511 thereby performs avoidance control when a collision is estimated or activates safety devices in the event of a collision.

The optical detection system 501 is also connected to the alarm device 512 that issues an alarm to the driver based on the determination result of the collision determination unit. For example, if the determination result of the collision determination unit indicates a high possibility of a collision, the main control unit 513 performs vehicle control to avoid the collision or reduce the damage by applying the brakes, releasing the accelerator, and/or reducing the engine output. The alarm device 512 warns the user by sounding an alarm, displaying alarm information on the screen of a display unit, such as a car navigation system and a meter panel, and/or vibrating the seat belt or the steering wheel.

In the present exemplary embodiment, the optical detection system 501 captures images of the surroundings of the vehicle 500, such as the front or rear. FIG. 19B illustrates a layout example of the optical detection system 501 in a case where the optical detection system 501 captures images in front of the vehicle.

As described above, the photoelectric conversion apparatuses 502 are disposed on the front of the vehicle 500. Specifically, to obtain distance information between the vehicle 500 and an object and determine the possibility of a collision, the two photoelectric conversion apparatuses 502 are desirably symmetrically arranged about an axis of symmetry, with the centerline of the vehicle 500 in the forward-backward direction or with respect to the outer shape thereof (e.g., vehicle width) as the axis of symmetry. The photoelectric conversion apparatuses 502 are also desirably located to not obstruct the driver's field of view when the driver visually observes the conditions outside the vehicle 500 from the driver's seat. The alarm device 512 is desirably located at a position easily visible to the driver.

Next, a fault detection operation of the photoelectric conversion apparatuses 502 in the optical detection system 501 will be described with reference to FIG. 21. The fault detection operation of the photoelectric conversion apparatuses 502 can be performed based on steps S110 to S180 illustrated in FIG. 21.

Step S110 is a step for making startup settings of the photoelectric conversion apparatuses 502. Specifically, settings for operating the photoelectric conversion apparatuses 502 are transmitted from outside the optical detection system 501 (e.g., main control unit 513) or inside the optical detection system 501 to start an imaging operation and the fault detection operation of the photoelectric conversion apparatuses 502.

In step S120, pixel signals are acquired from effective pixels. In step S130, an output value from a fault detection pixel provided for fault detection purposes is acquired. The fault detection pixel includes a photoelectric conversion element like the effective pixels. A predetermined voltage is written to this photoelectric conversion element. The fault detection pixel outputs a signal corresponding to the voltage written to the photoelectric conversion element. Steps S120 and S130 may be performed in a reverse order.

In step S140, it is determined whether an expected output value of the fault detection pixel and the actual output value of the fault detection pixel are the same. If the expected output value and the actual output value are determined to be the same in step S140 (YES in step S140), the processing proceeds to step S150. In step S150, the imaging operation is determined to be normally performed. The processing proceeds to step S160. In step S160, the pixel signals of the scanned row are transmitted to and temporarily stored in the memory 505. The processing then returns to step S120 to continue the fault detection operation. On the other hand, if the expected output value and the actual output value are determined to not be the same in step S140 (NO in step S140), the processing proceeds to step S170. In step S170, the imaging operation is determined to be abnormal, and an alarm is issued to the main control unit 513 or the alarm device 512. The alarm device 512 displays the detection of the abnormality on the display unit. In step S180, the photoelectric conversion apparatuses 502 are stopped, and the operation of the optical detection system 501 ends.

In the present exemplary embodiment, the flowchart is described to loop row by row. However, the flowchart may loop in units of several rows. The fault detection operation may be performed frame by frame. The alarm in step S170 may be issued and notified to outside the vehicle 500 via a wireless network.

While the present exemplary embodiment has dealt with a control to avoid a collision with other vehicles, the optical detection system 501 is also applicable to automatic driving control to follow another vehicle or automatic driving control to stay in the lane. Moreover, the optical detection system 501 is not limited to vehicles such as the own vehicle and can be applied to moving bodies (moving apparatuses), such as a ship, an aircraft, and an industrial robot, for example. Furthermore, the optical detection system 501 is not limited to a moving body, either, and can be widely applied to devices using object recognition, such as an intelligent transportation system (ITS).

### Sixth Exemplary Embodiment

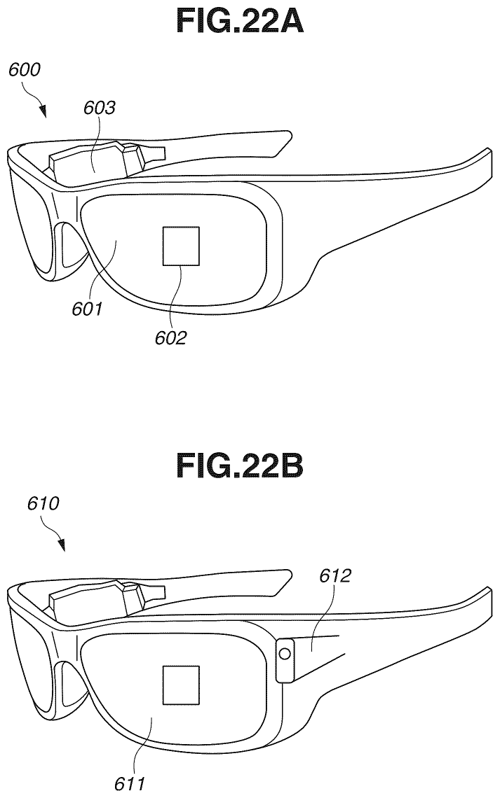

An optical detection system according to a sixth exemplary embodiment of the present invention will be described with reference to FIGS. 22A and 22B. FIGS. 22A and 22B are schematic diagrams illustrating configuration examples of the optical detection system according to the present exemplary embodiment. In the present exemplary embodiment, glasses (smart glasses) will be described as application examples of an optical detection system to which the photoelectric conversion apparatus 100 according to the first exemplary embodiment is applied.

FIG. 22A illustrates glasses 600 (smart glasses) according to an application example. The glasses 600 include lenses 601, a photoelectric conversion apparatus 602, and a control apparatus 603.

The photoelectric conversion apparatus 602 is the photoelectric conversion apparatus 100 described in the first exemplary embodiment, and disposed on a lens 601. There may be one or more photoelectric conversion apparatuses 602. If a plurality of photoelectric conversion apparatuses 602 is used, a plurality of types of photoelectric conversion apparatuses 602 may be used in combination. The position of the photoelectric conversion apparatus 602 is not limited to that illustrated in FIG. 22A. A display device (not illustrated) including a light emission device, such as an organic light-emitting diode (OLED) and an LED, may be disposed on the backside of the lens 601.

The control apparatus 603 functions as a power supply for supplying power to the photoelectric conversion apparatus 602 and the foregoing display device. The control apparatus 603 has a function of controlling the operation of the photoelectric conversion apparatus 602 and the display device. The lens 601 includes an optical system for collecting light to the photoelectric conversion apparatus 602.

FIG. 22B illustrates glasses 610 (smart glasses) according to another application example. The glasses 610 includes lenses 611 and a control device 612. The control device 612 can include a not-illustrated photoelectric conversion apparatus corresponding to the photoelectric conversion apparatus 602 and a not-illustrated display device.

A lens 611 is equipped with the photoelectric conversion apparatus in the control device 612 and an optical system for projecting light from the display device, whereby an image is projected on the lens 611. The control device 612 functions as a power supply for supplying power to the photoelectric conversion apparatus and the display device, and also has a function of controlling the operation of the photoelectric conversion apparatus and the display device.

The control device 612 may further include a line of sight detection unit that detects the line of sight of the wearer. In such a case, the control unit 612 may include an infrared light emission unit, and infrared rays emitted from the infrared light emission unit can be used to detect the line of sight. Specifically, the infrared light emission unit issues infrared rays toward the user's eyeball gazing at a displayed image. An imaging unit including a light receiving element detects reflection of the emitted infrared rays from the eyeball, whereby a captured image of the eyeball can be obtained. It is possible to reduce a drop in image quality by providing a reduction unit configured to reduce light from the infrared light emitting unit to the display unit in a plan view.

The user's line of sight to the displayed image can be detected from the captured image of the eyeball obtained by infrared imaging. Any conventional technique can be applied to the line of sight detection that uses the captured image of the eyeball. For example, a line of sight detection method can be used that is based on a Purkinje image formed by the reflection of the illumination light on the cornea. More specifically, line of sight detection processing based on the pupil-cornea reflection method is performed. The user's line of sight is detected by calculating a line of sight vector indicating the direction (rotation angle) of the eyeball based on the pupil image and the Purkinje image included in the captured image of the eyeball, using the pupil-cornea reflection method.

The display device according to the present exemplary embodiment may include a photoelectric conversion apparatus having a light receiving element and be configured to control the displayed image based on the user's line of sight information from the photoelectric conversion apparatus. Specifically, the display device determines a first field of view region at which the user is gazing and a second field of view region other than the first field of view region, based on the line of sight information. The first field of view region and the second field of view region may be determined by a control apparatus of the display device or by an external control apparatus. If the external control apparatus determines the field of view regions, the determination results are conveyed to the display device via communication. The display resolution of the first field of view region may be controlled to be higher than that of the second field of view region on the display area of the display device. In other words, the second field of view region may have a resolution lower than that of the first field of view region.

The display area may include a first display region and a second display region different from the first display region, and a region of higher priority may be determined between the first and second display regions based on the line of sight information. The first and second display regions may be determined by the control apparatus of the display device or by an external control apparatus. If the external control apparatus determines the display regions, the determination results are conveyed to the display device via communication. The resolution of the region of higher priority may be controlled to be higher than that of the region other than the region of higher priority. In other words, the region of relatively low priority may have a low resolution.

The first field of view region or the region of higher priority may be determined using artificial intelligence (AI). The AI may be a model that is configured to estimate from the eyeball image the angle of the line of sight and the distance to an object in front of the line of sight, by using eyeball images and the actual viewing directions of the eyeballs in the images as training data. The display device, the photoelectric conversion apparatus, or an external apparatus may include such an AI program. If the external apparatus includes the AI program, the estimation results are transmitted to the display device via communication.

If display control is performed based on visual detection, smart glasses further including a photoelectric conversion apparatus for capturing the outside can be suitably used. The smart glasses can display the captured external information in real time.

### Modified Exemplary Embodiments

The present invention is not limited to the foregoing exemplary embodiments, and various modifications can be made thereto.

For example, exemplary embodiments of the present invention also include examples where some of the components of one of the foregoing exemplary embodiments are added to another exemplary embodiment or replaced with some of the components of another exemplary embodiment.

In the foregoing first exemplary embodiment, low withstand voltage transistors and high withstand voltage transistors are described as the transistors constituting the pixel circuits. However, the transistors with different withstand voltages do not necessarily need to be two types, and three or more types of transistors may be used.

In the foregoing first exemplary embodiment, the signal IN1 is described to be output from the connection node between the cathode of the photon detection element 22 and the quenching element 24. However, the configuration of the photoelectric conversion unit 20 is not limited thereto. For example, the quenching element 24 may be connected to the anode of the photon detection element 22, and the signal IN1 may be obtained from the connection node between the anode of the photon detection element 22 and the quenching element 24.

Transistors or other switches may be disposed between the photon detection element 22 and the quenching element 24 and/or between the photoelectric conversion unit 20 and the pixel signal processing unit 30 to control the electrical connection between such components. Transistors or other switches may be disposed between the node to which the voltage VH is supplied and the quenching element 24 and/or between the node to which the voltage VL is supplied and the photon detection element 22 to control the electrical connection between such components.

In the foregoing first exemplary embodiment, the pixel signal processing unit 30 is described to use the counter 34. However, a time-to-digital converter (TDC) and a memory may be used instead of the counter 34. In such a case, the generation timing of the pulse signal output from the signal processing circuit 32 is converted into a digital signal by the TDC. In measuring the timing of the pulse signal, a control pulse pREF (reference signal) is supplied from the vertical scanning circuit unit 40 to the TDC via the control line 14. With reference to the control pulse pREF, the TDC obtains a digital signal indicating the input timing of the signal output from each pixel 12 in terms of a relative time.

As employed herein, the polarity of transistors and semiconductor regions may be expressed in terms of “conductivity types”. For example, with an N-type as a first conductivity type, a P-type is referred to as a second conductivity type. With an N-type as a second conductivity type, a P-type is referred to as a first conductivity type.

The foregoing exemplary embodiments are merely examples of embodiment for carrying out the present invention, and should not be construed as limiting the technical scope of the present invention. In other words, the present invention can be carried out in various forms without departing from the technical concept or main features thereof.

The present invention is not limited to the foregoing exemplary embodiments, and various changes and modifications can be made without departing from the sprit or scope of the present invention. The following claims are therefore appended to make the scope of the present invention public.

According to the present invention, the area efficiency of the elements constituting the pixel circuits can be improved to enhance the performance or functionality of the photoelectric conversion apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A photoelectric conversion apparatus comprising
a pixel including:
a photoelectric conversion unit configured to output a first signal in response to incidence of a photon, the photoelectric conversion unit including an avalanche diode configured to multiply a charge occurring from the incidence of the photon by avalanche multiplication;
a counter configured to count the first signal output from the photoelectric conversion unit; and
a signal processing circuit connected between the counter and the photoelectric conversion unit and configured to control output of a third signal based on the first signal and a second signal,
wherein the signal processing circuit includes a first element having a first withstand voltage and a second element having a second withstand voltage and is configured such that the first signal is input to the first element and the second signal is input to the second element, the second withstand voltage being a withstand voltage lower than the first withstand voltage.

2. A photoelectric conversion apparatus comprising
a pixel including:
a photoelectric conversion unit configured to output a first signal in response to incidence of a photon, the photoelectric conversion unit including an avalanche diode configured to multiply a charge occurring from the incidence of the photon by avalanche multiplication;
a counter configured to count the first signal output from the photoelectric conversion unit; and
a signal processing circuit connected between the counter and the photoelectric conversion unit and configured to control output of a third signal based on the first signal and a second signal,
wherein the signal processing circuit includes a first element and a second element, and is configured such that the first signal is input to the first element and the second signal is input to the second element, and
wherein a gate insulting film of a transistor included in the first element has a thickness greater than that of a gate insulating film of a transistor included in the second element.

3. The photoelectric conversion apparatus according to claim 1,
wherein the first signal has a first amplitude, and
wherein the second signal has a second amplitude smaller than the first amplitude.

4. The photoelectric conversion apparatus according to claim 1, wherein the third signal is a pulse signal into which the first signal is converted, the first signal being an analog signal.

5. The photoelectric conversion apparatus according to claim 1, wherein the third signal is an output signal from an inverter circuit included in the signal processing circuit.

6. The photoelectric conversion apparatus according to claim 1, wherein the second signal is a signal configured to control the output of the third signal from the signal processing circuit.

7. The photoelectric conversion apparatus according to claim 1, wherein the second element is controlled if a count value of the counter reaches a predetermined value.

8. The photoelectric conversion apparatus according to claim 1, wherein record time information about when a count value of the counter reaches a predetermined value is recorded.

9. The photoelectric conversion apparatus according to claim 8, further comprising an acquisition unit configured to acquire a predicted count value based on the time information.

10. The photoelectric conversion apparatus according to claim 1, wherein the signal processing circuit includes a plurality of first elements and a plurality of second elements and has a first area in which the plurality of first elements is disposed and a second area in which the plurality of second elements is disposed.

11. The photoelectric conversion apparatus according to claim 1,
wherein the photoelectric conversion unit further includes a quenching element configured to suppress the avalanche multiplication by the avalanche diode, and
wherein the quenching element includes a third element having a withstand voltage higher than that of the second element.

12. The photoelectric conversion apparatus according to claim 1, wherein a power supply voltage supplied to the first element and a power supply voltage supplied to the second element are same.

13. An optical detection system comprising:
the photoelectric conversion apparatus according to claim 8; and
an acquisition apparatus configured to acquire a predicted count value based on the time information.

14. An optical detection system comprising:
the photoelectric conversion apparatus according to claim 1; and
a signal processing apparatus configured to process a signal output from the photoelectric conversion apparatus.

15. The optical detection system according to claim 14, wherein the signal processing apparatus is configured to generate a distance image indicating information about a distance to an object based on the signal.

16. A moving body comprising:
photoelectric conversion apparatus according to claim 1;
a distance information acquisition unit configured to acquire information about a distance to an object from a parallax image based on a signal output from the photoelectric conversion apparatus; and
a control unit configured to control the moving body based on the information about the distance.
